(19) United States
(12) Patent Application Publication
(10) Pub. No.: US 2012/0102086 A1
(43) Pub. Date: Apr. 26, 2012

(54) PROCESSING NODE SELECTION SYSTEM, INFORMATION PROCESSING NODE, PROCESSING EXECUTION METHOD AND PROGRAM

(76) Inventors: Michitaro Miyata, Tokyo (JP); Masaki Kan, Tokyo (JP)

(21) Appl. No.: 13/379,849

(22) PCT Filed: Jun. 18, 2010
(86) PCT No.: PCT/JP2010/060348

§ 371 Date: Dec. 21, 2011

(30) Foreign Application Priority Data
Jun. 22, 2009 (JP) 2009-148046

(51) Int. Cl. G06F 15/16

(52) U.S. Cl. 709/201

(57) ABSTRACT

A processing node selection system comprises: a first node that has a processing resource; and a second node that has a processing resource and stores data used in processing. A selection is made of a node with a smaller total volume of data to be exchanged between the first and second nodes, as a node to execute the processing when processing is executed using data stored in the second node and the processing result is outputted by the first node.

### TECHNICAL FIELD

### Description of Related Application

This application claims the benefit of Japanese Patent Application No. 2009-148046, filed on Jun. 22, 2009, which is incorporated by reference herein in its entirety. The present invention relates to a processing node selection system, an information processing node, a processing execution method and computer-readable storage medium storing a program, and in particular to a processing node selection system that has a plurality of information processing nodes (referred to below as simply “processing node” or “node”) and that selects a processing node to process a processing request from a client, and an information processing node, a processing execution method and a computer-readable storage medium storing a program therefor.

### BACKGROUND

In client-server models, examples are known in which a system corresponding to a server is configured from a plurality of application nodes and a plurality of storage nodes. The application nodes are nodes provided with processing execution resources that are formed, for example, of a CPU (Central Processing Unit) and a memory, and the storage nodes are nodes provided with a storage medium that is formed, for example, of a hard disk drive, and that stores data used in processing execution.

A description concerning operation in this type of system is given using FIG. 27. When a client transmits a processing request V1 to an application node via a network, the application node transmits a data request V2 to a storage node. Next, the storage node 2 transmits data V3 to the application node, and the application node performs execution of the requested processing using this data and transmits a processing result V4 to the client.

Furthermore, in this type of system, technology is known in which a processing resource is added to the storage node, and by making use of the processing resource that is used by the storage node for storage processing, a part of the processing executed by an application node is delegated to the storage node to be executed by the storage node. Non-Patent Document 1, for example, describes technology to perform data base reorganization in a storage system.

FIG. 28 is a diagram showing operation of a system in which processing is delegated to the storage node described above. When a client transmits a processing request W1 to an application node, the application node transmits a processing request W2 to the storage node. Next, the storage node transmits a processing result W3 to the application node, and the application node transmits a processing result W4 to the client.

JP Kohyo Publication No. JP-P2005-512232A is a patent document that refers to storage nodes. According to this document, the system does not perform delegation of processing as in Non-Patent Document 1 described above, but a system management server monitors an application's use of network storage, and transparently and dynamically reallocates a virtual segment to an optimal physical storage resource.
[Patent Document 1] JP Kohyo Publication No. JP-P2005-512232A
[Non-Patent Document 1] Kazuo Goda, Masaru Kitsuregawa, Introducing Database Reorganization into Storage Systems, Technical Report of IEICE, The Institute of Electronics, Information and Communication Engineers, Vol. 104, No. 537, pp. 61-66.

### SUMMARY

The entire disclosures of the abovementioned Patent Document 1 and Non-Patent Document 1 are incorporated herein by reference thereto. An analysis of related technology according to the present invention is given below. In a system of a configuration as described above, since it is necessary to transmit a processing result or data both in a case of executing processing by an application node and in a case of executing processing by a storage node, when the number of processing requests from a client increases, congestion may occur in an internal network between the abovementioned application node and storage node, and a response delay may occur with respect to a processing request (refer to the internal network 8 of FIG. 1).

Referring to FIG. 27 and FIG. 28, communication traffic volume in an internal network generated by one processing request, in the case of FIG. 27, is the sum of data volumes of a data request V2 and data V3, and in the case of FIG. 28, is the sum of data volumes of a processing request W2 and a processing result W3. In general the data volume of the data request V2 and the processing request W2 is approximately several bytes to several 100 bytes, whereas the data volume of the data V3 and the processing result W3 is a volume of from several kilobytes to more than a gigabyte. That is, with regard to the communication traffic volume of the internal network, the contribution of the data V3 or the processing result W3, which are communications from the storage node to the application node, is large.

Comparing the case of performing processing execution by the application node as in FIG. 27, and the case of performing processing execution by the storage node as in FIG. 28, it is not uniquely determined which has a lower communication traffic volume from the storage node to the application node, that is, which data volume among the data V4 and the processing result W3 with respect to the same processing request from the client, is smaller. This is because size relationship characteristic of the data volumes before and after processing is different according to the type of processing. That is, this is because there are two cases: that in which the data volume before processing is larger and that in which the data volume after processing (processing result) is larger.

For example, in general the data volume before processing is larger for data compression processing, and the data volume after processing is larger for decompression processing of compressed data. As a result, in a system that mixes processing with different size relationship characteristics for data volumes before and after processing, there is a problem in that, even if a selection is made to either employ a method in which the processing execution of FIG. 27 is performed by an application node, or a method in which the processing execution of FIG. 28 is performed by a storage node, a state occurs in which it is not possible to reduce the communication traffic volume from the storage node to the application node.

Therefore, it is an object of the present invention to provide a processing node decision system, an information processing node, a processing node decision method and a program, by which, in a configuration where either of two nodes executes processing using node data of one of the two nodes, and the other node is an output destination, it is possible to ensure a required response performance regardless of processing content.

According to a first aspect of the present invention, there is provided a processing node selection system characterized by comprising: a first node that has a processing resource; and a second node that has a processing resource and stores data used in processing; wherein a selection is made of a node with a smaller total volume of data to be exchanged between the first and second nodes, as a node to execute the processing when processing is executed using data stored in said second node and the processing result is outputted by the first node.

According to a second aspect of the present invention, with regard to the processing node selection system described above, there is provided an information processing node that performs node selection processing.

According to a third aspect of the present invention, there is provided a processing execution method of executing processing by either of a first node that has a processing resource, and a second node that has a processing resource and stores data used in processing. The method comprises: a step that selects a node with a smaller total volume of data to be exchanged between the first and second nodes, among either of a case of transmitting data stored in the second node to the first node and executing processing by the first node, or a case of executing processing by the second node and transmitting a processing result thereof to the first node; and a step in which the selected node executes the processing. It is to be noted that the present method is linked with a specific apparatus, known as an information processing node that determines the processing node.

According to a fourth aspect of the present invention, there is provided a program included in an information processing system that executes processing in either of a first node that has a processing resource and a second node that has a processing resource and stores data used in specific processing. The program causes execution in an information processing node including either the first node and the second node, and the program causing the computer to execute: a process of computing a ratio of data volumes before and after processing according to the specific processing; and a process of determining a node to execute the specific processing so as to have a small total volume of data exchanged between the first and second nodes, based on the data volume ratio. It is to be noted that this program can be recorded in a computer readable storage medium. That is, the present invention can be embodied as a computer program product. The program may be stored on a computer-readable storage medium. Also the program may be regarded as either a program product (i.e. manufacture) or a process embodying the data storage method (process), expressed in a program language.

The meritorious effects of the present invention are summarized as follows.

According to the present invention, in a configuration where either of two nodes executes processing using node data of one of the two nodes, and the other node is an output destination, it is possible to prevent deterioration in response performance that may occur due to processing having a different size relationship characteristic for data volumes before and after processing.

### BRIEF DESCRIPTION OF THE DRAWINGS

FIG. 1 is a block diagram showing a configuration of an overall system in first and second exemplary embodiments of the present invention;

FIG. 2 is a block diagram showing a configuration of an application node in the first exemplary embodiment of the present invention;

FIG. 3 is a block diagram showing a configuration of a storage node in the first exemplary embodiment and a third exemplary embodiment of the present invention;

FIG. 4 is a diagram showing a structure of a data information storage unit in the first and third exemplary embodiments of the present invention;

FIG. 5 is a diagram showing a structure of a data volume storage unit in the first and third exemplary embodiments of the present invention;

FIG. 6 is a diagram showing a structure of a data volume ratio storage unit in the first exemplary embodiment of the present invention;

FIG. 7 is a flow chart showing operations of the application node in the first and third exemplary embodiments of the present invention;

FIG. 8 is a flow chart showing operations of the storage node in the first and third exemplary embodiments of the present invention;

FIG. 9 is a block diagram representing a schematic configuration for describing specific operations of the first exemplary embodiment of the present invention;

FIG. 10 is a diagram for describing specific operations of the first exemplary embodiment of the present invention (a specific example of information stored in the data information storage unit);

FIG. 11 is a diagram for describing specific operations of the first exemplary embodiment of the present invention (a specific example of information stored in the data volume storage unit);

FIG. 12 is a diagram for describing specific operations of the first exemplary embodiment of the present invention (a specific example of information stored in the data volume storage unit);

FIG. 13 is a diagram for describing specific operations of the first exemplary embodiment of the present invention (a specific example of information stored in the data volume storage unit);

FIG. 14 is a diagram for describing specific operations of the first exemplary embodiment of the present invention (a specific example of information stored in the data volume ratio storage unit);

FIG. 15 is a diagram for describing specific operations of the first exemplary embodiment of the present invention (a specific example of information stored in the data volume ratio storage unit);

FIG. 16 is a diagram for describing specific operations of the first exemplary embodiment of the present invention (a specific example of information stored in the data volume ratio storage unit);

FIG. 17 is a block diagram showing a configuration of an application node in the second exemplary embodiment of the present invention;

FIG. 18 is a block diagram showing a configuration of a storage node in the second exemplary embodiment of the present invention;

FIG. 19 is a diagram showing a structure of a data information storage unit in the second exemplary embodiment of the present invention;

FIG. 20 is a diagram showing a structure of a data volume storage unit in the second exemplary embodiment of the present invention;

FIG. 21 is a diagram showing a structure of a data volume ratio storage unit in the second exemplary embodiment of the present invention;

FIG. 22 is a flow chart showing operations of the application node in the second exemplary embodiment of the present invention;

FIG. 23 is a flow chart showing operations of the storage node in the second exemplary embodiment of the present invention;

FIG. 24 is a block diagram showing a configuration of an overall system in the third exemplary embodiment of the present invention;

FIG. 25 is a block diagram showing a configuration of an application node in the third exemplary embodiment of the present invention;

FIG. 26 is a diagram showing a structure of a data volume ratio storage unit in the third exemplary embodiment of the present invention;

FIG. 27 is a diagram for describing operations in which an application node and a storage node execute processing requested by a client; and

FIG. 28 is another diagram for describing operations in which an application node and a storage node execute processing requested by a client.

### PREFERRED MODES

First, a description is given of an outline of an exemplary embodiment of the present invention. A processing node selection system of the exemplary embodiment of the present invention is configured from a first node that is provided with a processing resource, a second node that is provided with a processing resource and that stores data to be used in processing, and a third node (either of the first or second node is also possible) that selects which of the first node or the second node is to execute processing that is to be executed by either the first node or the second node.

The third node (either the first or the second node is also possible) selects the node with a smaller total volume of data to be exchanged between the first and second nodes.

Very simply, it is possible to select the node using a ratio of data volumes before processing and after processing. That is, as in data compression processing described above, in a case where the data volume before processing is larger than the data volume after processing, executing the processing by the second node that is holding the data can enable a decrease in the total data volume exchanged between the first and the second nodes. Conversely, as in data decompression processing described above, in a case where the data volume before processing is less than the data volume after processing, executing the processing by receiving data before processing by the first node can enable a decrease of the total data volume exchanged between the first and the second nodes. From the above, it is possible to realize an object of the present invention.

### First Exemplary Embodiment

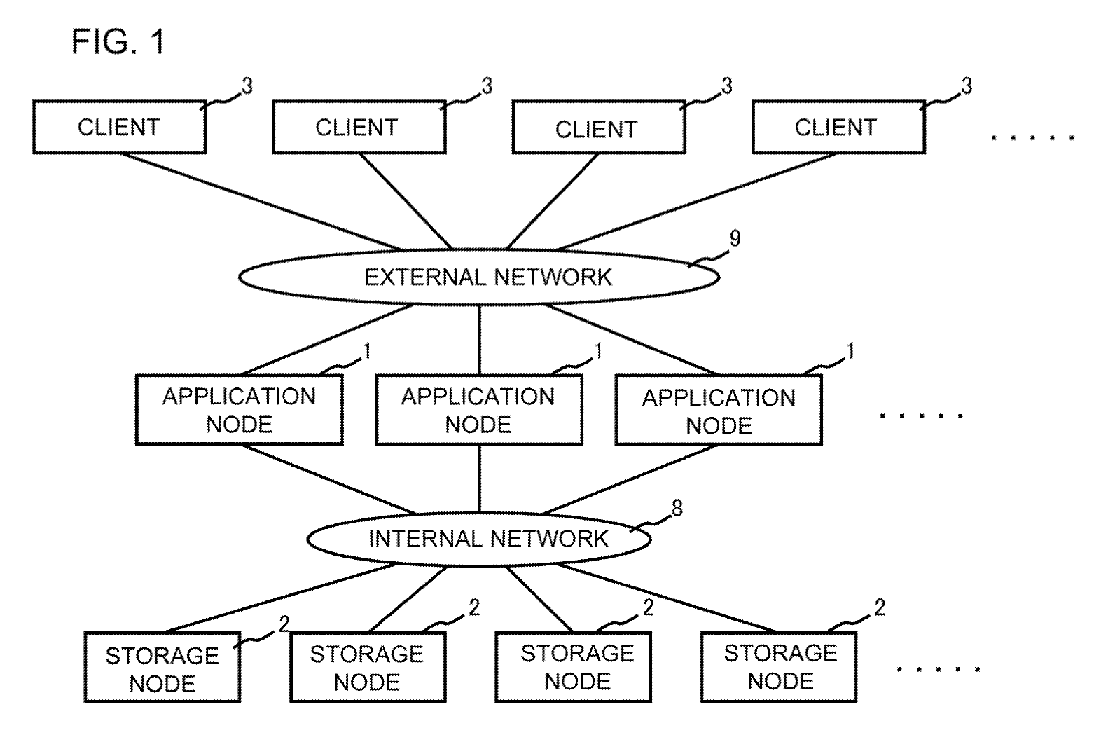

Next, a detailed description is given concerning a first exemplary embodiment of the present invention, making reference to the drawings. FIG. 1 is a block diagram showing a configuration of an overall system in the first exemplary embodiment of the present invention. Referring to FIG. 1, the first exemplary embodiment of the present invention is configured from: a plurality of application nodes 1, a plurality of storage nodes 2, a plurality of clients 3, an internal network 8, and an external network 9.

The application nodes 1 and the storage nodes 2 are connected via the internal network 8.

The application nodes 1 and the clients 3 are connected via the external network 9.

An application node 1 receives a processing request from a client 3, makes a processing request or a data request to a storage node 2, transmits to the client 3 a processing result received from the storage node 2 in a case where the processing request was made with regard to the storage node 2, and executes processing on received data in a case where the data request was made with regard to the storage node 2 and transmits a processing result to the client 3.

The storage node 2 stores data to be used in processing, and in a case of receiving the processing request from the application node 1, executes the processing and transmits a processing result to the application node 1, and in a case of receiving the data request from the application node 1, transmits the data to the application node 1.

The client 3 makes a processing request with regard to the application node 1, and receives a processing result from the application node 1.

The internal network 8 provides a communication path between the application node 1 and the storage node 2.

The external network 9 provides a communication path between the application node 1 and the client 3.

### (Configuration of Application Node 1)

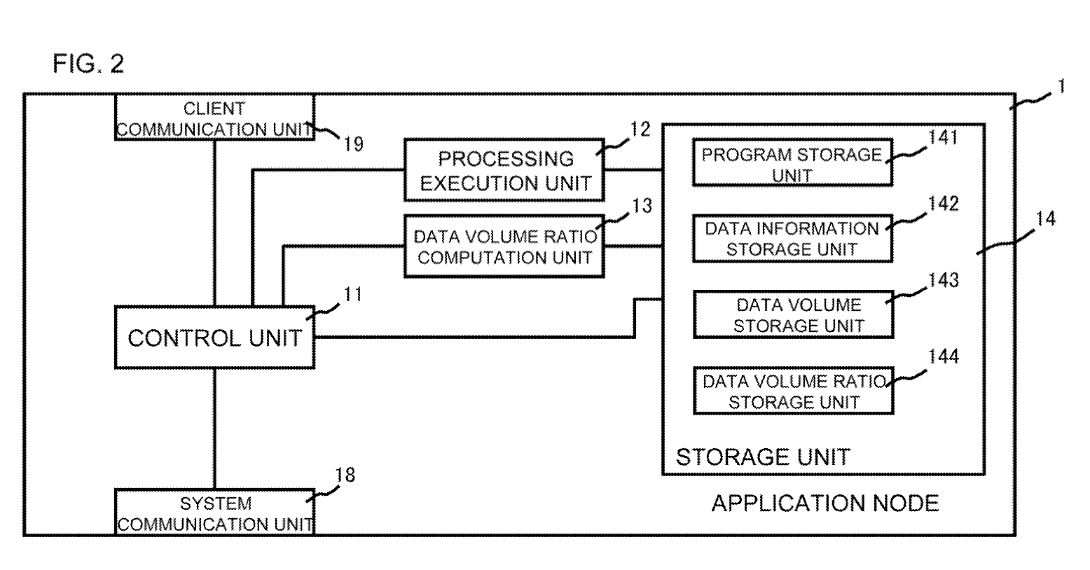

Next, a detailed description is given of a configuration of the application node 1 using FIG. 2 and FIG. 4 to FIG. 6.

FIG. 2 is a block diagram showing a configuration of the application node 1 in the present exemplary embodiment. Referring to FIG. 2, the application node 1 is configured by including a control unit 11, a processing execution unit 12, a data volume ratio computation unit 13, a storage unit 14, a system communication unit 18, and a client communication unit 19.

The control unit 11 controls overall operations of the application node 1. The processing execution unit 12 reads and executes a program stored in the program storage unit 14. The control unit 11, the processing execution unit 12, a program storage unit 141, and a memory not shown in the drawings are positioned as processing resources.

The data volume ratio computation unit 13 computes an average value of a ratio of data volumes before and after processing, from data volumes before processing and after processing as stored in a data volume storage unit 143 for each program, and stores the value in a data volume ratio storage unit 144.

The control unit 11, the processing execution unit 12, and the data volume ratio computation unit 13 can be implemented as appropriate by software or hardware. For example, a computer system configured by a CPU (Central Processing Unit) and a memory storing a program is possible, and a dedicated electronic circuit is also possible. Furthermore, it is not necessary that two or more among the control unit 11, the processing execution unit 12, and the data volume ratio computation unit 13 be independent, and, for example, it is also possible to have physically the same system or circuit configuration.

The storage unit 14 is provided with the program storage unit 141, a data information storage unit 142, the data volume storage unit 143, and the data volume ratio storage unit 144. The storage unit 14 can be implemented by a hard disk drive, for example.

The program storage unit 141 stores a program that can be executed by the processing execution unit 12. The program storage unit 141 can store a plurality of programs. Below, an expression of executing processing by the application node 1 is used to have the same meaning as executing a program associated with processing by the processing execution unit 12 of the application node 1.

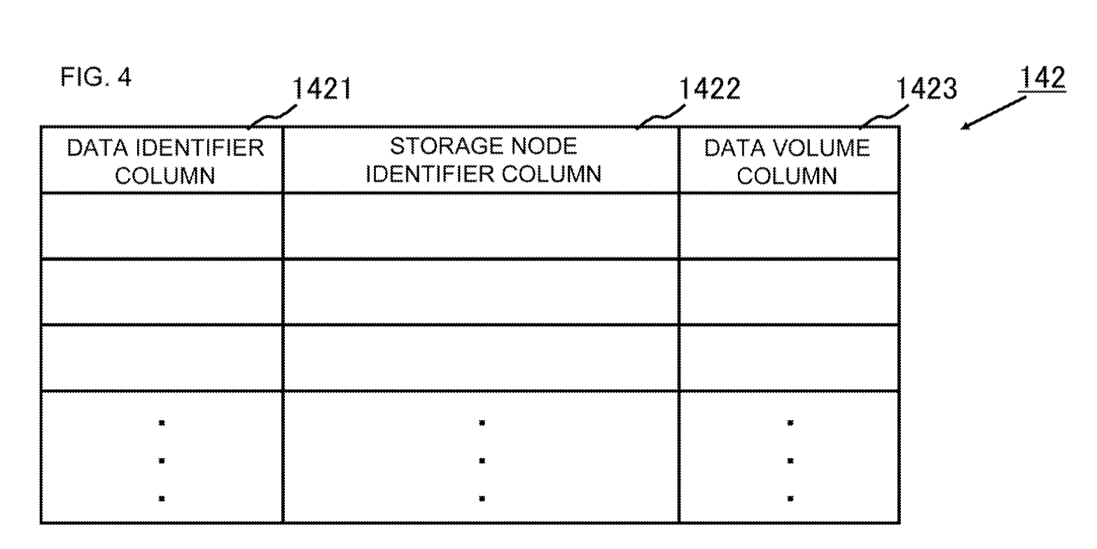

The data information storage unit 142 stores information related to data stored in the storage node 2. FIG. 4 is a diagram representing a data structure of the data information storage unit 142. In the exemplary embodiment of FIG. 4, the data information storage unit 142 has a tabular structure formed of a data identifier column 1421, a storage node identifier column 1422, and a data volume column 1423. The data identifier is an identifier for identifying data from among data possessed by all the storage nodes 2, and is, for example, an attached number or name such that duplication does not occur. The storage node identifier is an identifier for identifying one storage node 2 from among the storage nodes 2. The storage node identifier column contains the storage node identifiers of the storage nodes 2 that have data identifiers in the data identifier column 1421 of the same row. The data volume represents the size of the data by number of bytes. The data volume column 1423 stores the data volumes of data corresponding to the data identifiers in the data identifier column 1421 of the same row. There is no duplication of data identifiers in the data identifier column 1421. That is, specifying a data identifier uniquely identifies a row.

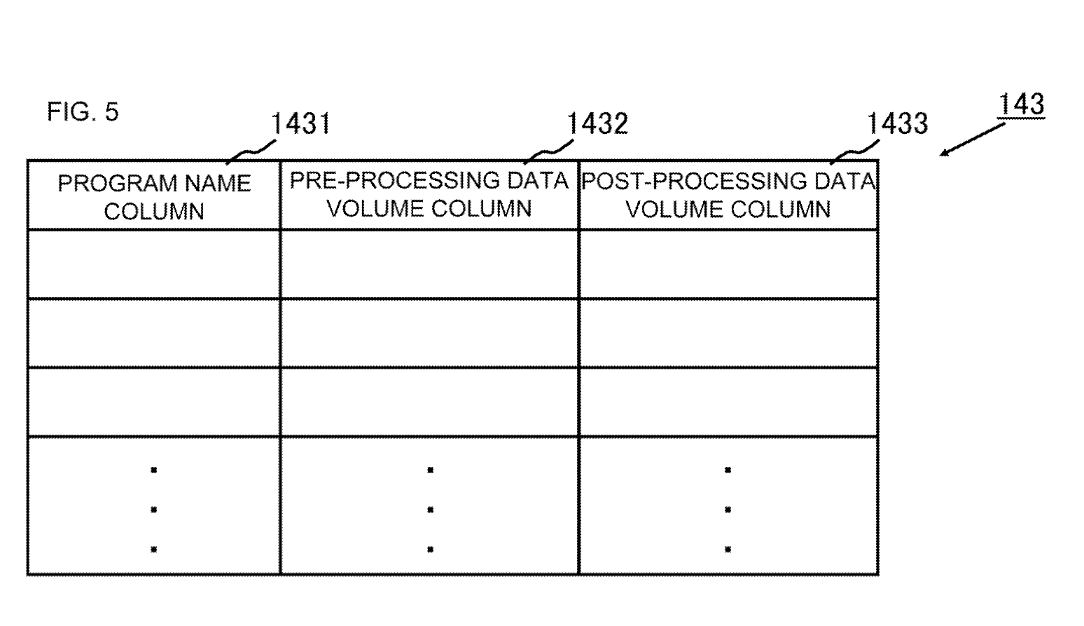

The data volume storage unit 143 stores the data volume before processing and the data volume after processing. FIG. 5 is a diagram representing a data structure of the data volume storage unit 143. In the example of FIG. 5, the data volume storage unit 143 has a tabular structure formed from a program name column 1431, a pre-processing data volume column 1432, and a post-processing data volume column 1433. The program name is a name for identifying one among a plurality of programs stored in the program storage unit 141. The pre-processing data volume is the volume of data that is inputted to a program. The post-processing data volume is the volume of data that is outputted from a program. For example, in a case of compressing data A by a compression program and generating data B, the pre-processing data volume is the data volume of data A, and the post-processing data volume is the data volume of data B. Each time a program is executed a row is additionally added to the data volume storage unit 143, and the same program name may be stored a number of times in the program name column 1431.

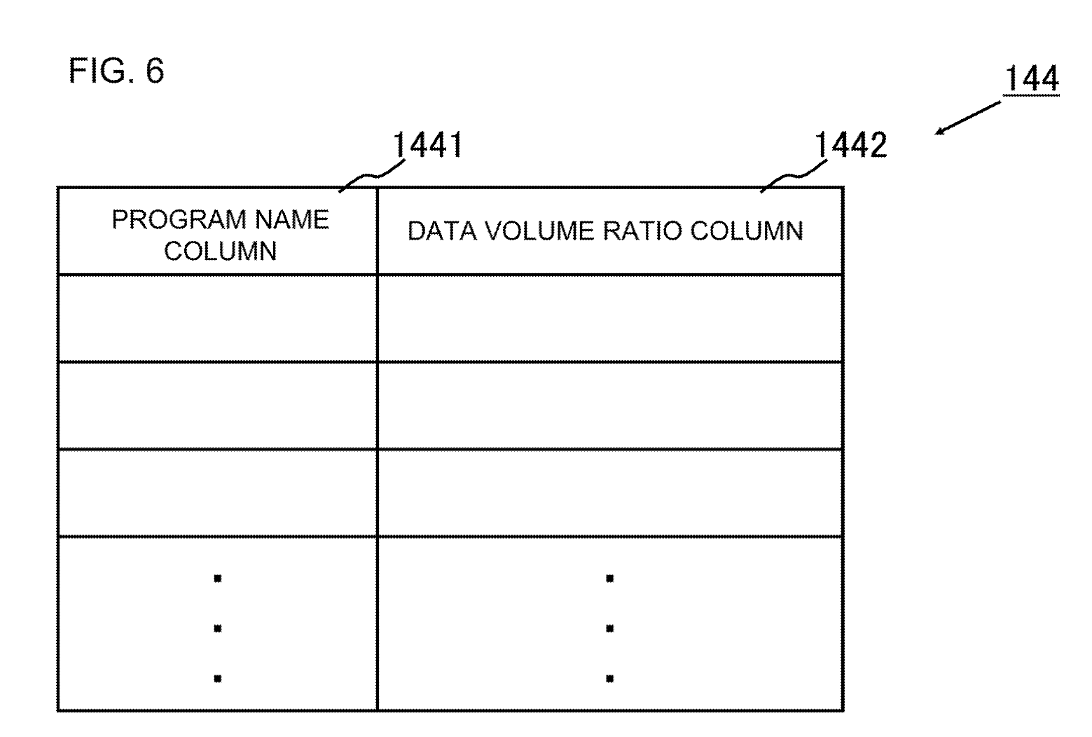

The data volume ratio storage unit 144 stores a ratio of the data volumes before and after processing. FIG. 6 is a diagram representing a data structure of the data volume storage unit 144. In the example of FIG. 6, the data volume ratio storage unit 144 has a tabular structure formed from the program name column 1441 and the data volume ratio column 1442. The data volume ratio is an average value for each program name of values obtained by dividing the post-processing data volume by the pre-processing data volume. A data volume ratio larger than 1, for a program concerned, indicates a tendency for the post-processing data volume to be larger than the pre-processing amount. On the other hand, a data volume ratio smaller than 1 indicates a tendency for the post-processing data volume to be smaller than the pre-processing data volume. Program names are not duplicated in the program name column 1441. That is, a row specifying a program name, namely the data volume ratio of that program, is uniquely identified.

The system communication unit 18 functions as an interface between inside the application nodes 1 and the internal network 8.

The client communication unit 19 functions as an interface between inside the application nodes 1 and the external network 9.

### (Configuration of Storage Node 2)

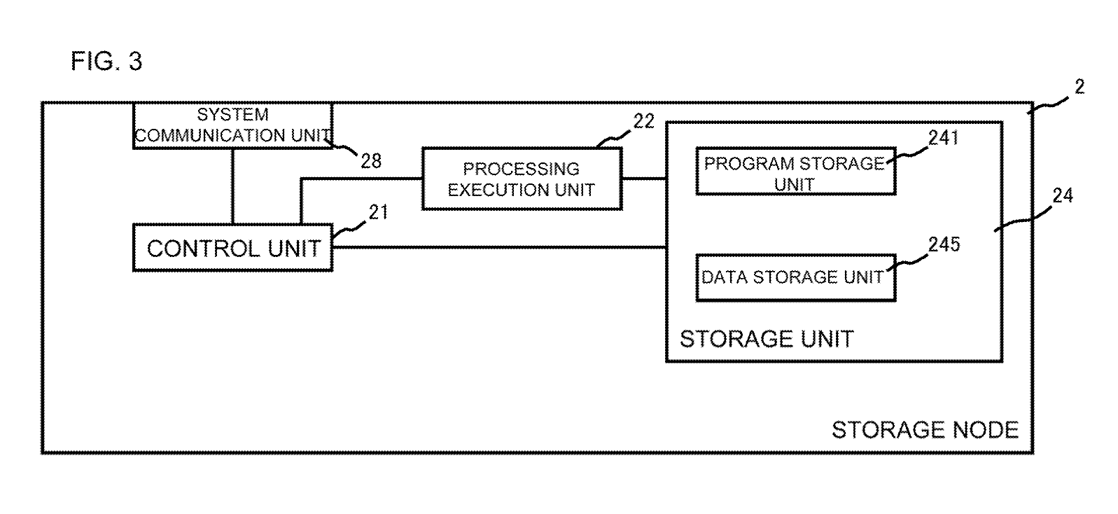

Next, a detailed description is given of a configuration of the storage node 2. FIG. 3 is a block diagram showing the configuration of the storage node 2 in the present exemplary embodiment. Referring to FIG. 3, the storage node 2 is configured by including a control unit 21, a processing execution unit 22, a storage unit 24, and a system communication unit 28.

The control unit 21 controls overall operation of the storage node 2. The processing execution unit 22 reads and executes a program stored in a program storage unit 241. The control unit 21, the processing execution unit 22, the program storage unit 241, and a memory not shown in the drawings are positioned as processing resources.

The control unit 21 and the processing execution unit 22 can be implemented as appropriate by software or hardware. For example, a computer system configured by a CPU (Central Processing Unit) and a memory storing a program is possible, and a dedicated electronic circuit is also possible. Furthermore, it is not necessary that the control unit 21 and the processing execution unit 22 be independent, and, for example, it is also possible to have physically the same system or circuit configuration.

The storage unit 24 is provided with a program storage unit 241 and a data storage unit 245. The storage unit 24 can be implemented by a hard disk drive, for example.

The program storage unit 241 stores a program that can be executed by the processing execution unit 22. The program storage unit 241 can store a plurality of programs. Below, an expression of executing processing by the storage node 2 is used to have the same meaning as executing a program associated with processing by the processing execution unit 22 of the storage node 2.

The data storage unit 245 stores data to be inputted to the processing.

The system communication unit 28 functions as an interface between inside the storage node 2 and the internal network 8. In the present exemplary embodiment, with regard to all programs required for a processing request from the client 3, the same program groups are stored in advance in the program storage unit 141 of all the application nodes 1 and in the program storage unit 241 of all the storage nodes 2. Furthermore, all data required for a processing request from the client 3 is assumed to be stored in any among the storage nodes 2, and information as to which data is stored in which storage node 2 is assumed to be stored in advance in the data information storage unit 142 of all of the application nodes 1.

### (Operations of Client 3)

Next, a description is given concerning operations of the client 3 in the present exemplary embodiment.

The client 3 transmits a processing request to any one of the application nodes 1, and waits for a processing result. The processing request includes specification of a program name and data identifier. Content of the processing request and timing of transmission are, for example, according to an instruction from a human who is operating the client 3, or a schedule set inside the client 3.

### (Operation of Application Node 1)

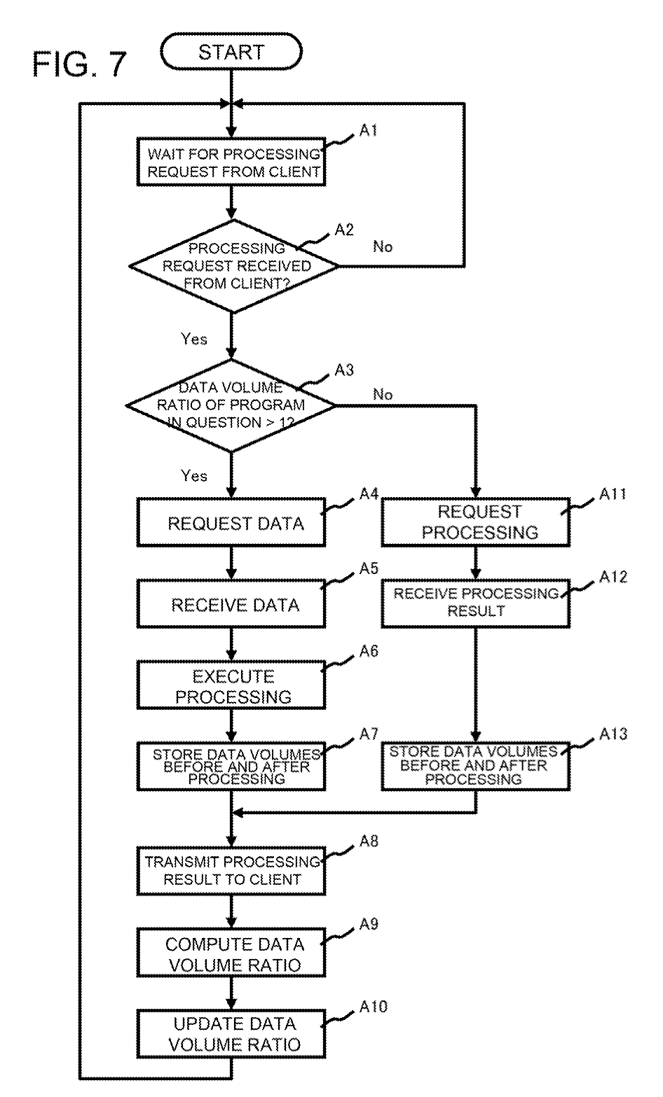

Next, a description is given concerning operation of the application node 1 of the present exemplary embodiment, making reference to a flowchart of FIG. 7.

First, the application node 1 waits to receive a processing request from the client 3 (step A1 in FIG. 7), and on receiving the processing request from the client 3 (step A2), searches for a row matching the program name included in the processing request from the processing name column 1441 of the data volume ratio storage unit 144, and checks whether or not a data volume ratio value stored in the data volume ratio column 1442 in the row concerned is larger than 1 or is less than or equal to 1 (step A3).

In step A3, in a case where the data volume ratio of a program specified in the processing request is larger than 1, the application node 1 transmits a data request to the storage node 2 (step A4). In step A4, the storage node 2 to which the data request is transmitted is assumed to be a storage node 2 that corresponds to a storage node identifier stored in the storage node identifier column 1422 in a row where a value of the data identifier column 1421 of the data information storage unit 142 matches the data identifier included in the processing request. Furthermore, the data request includes the data identifier that is included in the processing request received from the client.

Next, the application node 1 receives the data of the data request from the storage node 2 (step A5), and executes the program concerned in the processing execution unit 12 with the received data as input (step A6).

Next, the application node 1 secures a new row in the data volume storage unit 143 and respectively stores the executed program name in the program name column 1431, the data volume of the data received from the storage node 2 in the pre-processing data volume column 1432, and the data volume of the processing result in the post-processing data volume column 1433 (step A7).

In step A7, in a case where a new row cannot be secured due to there being little storage capacity in the data volume storage unit 143, the number of rows in the table of the data volume storage unit 143 is counted for each program name, the oldest row of the program name with the most rows is deleted, and storage area for a new row is obtained. Furthermore, a configuration is possible in which a predetermined number of rows is secured and old data rows are deleted in sequence, for each program.

Next, the application node 1 transmits a processing result executed on its own device side as described above, to the client 3 that is the source of the processing request (step A8). Next, the data volume ratio computation unit 13 of the application node 1 computes the value of the post-processing data volume divided by the pre-processing data volume for all rows where the program name column 1431 of the data volume storage unit 143 holds the program name concerned, and takes an average value thereof as a data volume ratio (step A9).

Next, the application node 1 updates the data volume ratio column 1442 in the row where the program name concerned is stored in the program name column 1441 of the data volume ratio storage unit 144, to the value of the computed data volume ratio (step A10). Thereafter, the application node 1 returns to step A1 and transitions to a state of waiting for a processing request from the client.

In step A3, in a case where the data volume ratio of the program specified in the processing request is 1 or less, the application node 1 transmits a processing request to the storage node 2 (step A11).

In step A11, the storage node 2 to which the processing request is transmitted is assumed to be a storage node 2 that corresponds to a storage node identifier stored in the storage node identifier column 1422 in a row where a value of the data identifier column 1421 of the data information storage unit 142 matches the data identifier included in the processing request. It is to be noted that the transmitted processing request includes the program name and data identifier included in the processing request received from the client 3.

Next, on receiving the processing result from the storage node 2 (step A12), the application node 1 secures a new row of the data volume storage unit 143, and respectively stores: a program name included in the processing request, in the program name column 1431; a value stored in the data volume column 1423 in a row where the value of the data identifier column 1421 of the data information storage unit 142 matches a data identifier included in the processing request, in the pre-processing data volume column 1432; and the data volume of the processing result received from the storage node 2, in the post-processing data volume column 1433 (step A13).

It is to be noted that in step A13, in a case where a new row cannot be secured due to there being little storage capacity in the data volume storage unit 143, the number of rows in the table of the data volume storage unit 143 is counted for each program name, the oldest row of the program name with the most rows is deleted, and storage area for a new row is obtained. Furthermore, a configuration is possible in which a predetermined number of rows is secured and old data rows are deleted in sequence, for each program.

Thereafter, similar to a case where the data volume ratio of a program specified in the processing request is larger than 1, transmission of the processing result to the client 3, computation of the data volume ratio, and updating of the data volume ratio are performed (steps A8 to A10).

### (Operation of Storage Node 2)

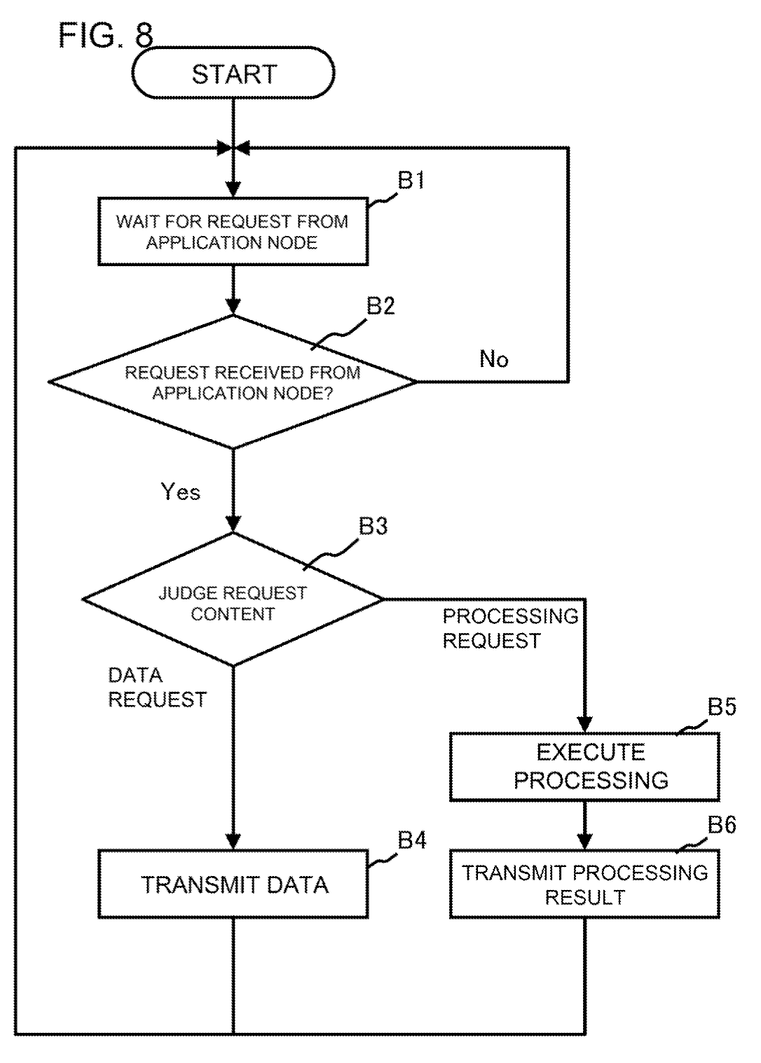

Next, a description is given concerning operation of the storage node 2 of the present exemplary embodiment, making reference to a flowchart of FIG. 8.

First, the storage node 2 waits for either a data request or a processing request from the application node 1 (step B1 in FIG. 8), and when a request is received from the application node 1 (step B2), a judgment is made of the request content as to whether it is a data request or a processing request (step B3).

In a case where the content of the request in step B3 is a data request, the storage node 2 reads data corresponding to a data identifier included in the data request from the data storage unit 245, and transmits the data to the application node 1 that is the source of the data request (step B4). Thereafter, the storage node 2 returns to step B1 and transitions to a state of waiting for a request from the application node 1.

On the other hand, in a case where the content of the request in step B3 is a processing request, the storage node 2 executes the program concerned in the processing execution unit 22 with data corresponding to a data identifier included in the processing request as input (step B5). Next, the storage node 2 transmits a processing result to the application node 1 that is the source of the processing request (step B6). Thereafter, the storage node 2 returns to step B1 and transitions to a state of waiting for a request from the application node 1.

### SPECIFIC EXAMPLE 1

Next, a description is given of specific operations of the first exemplary embodiment of the present invention using a simple example.

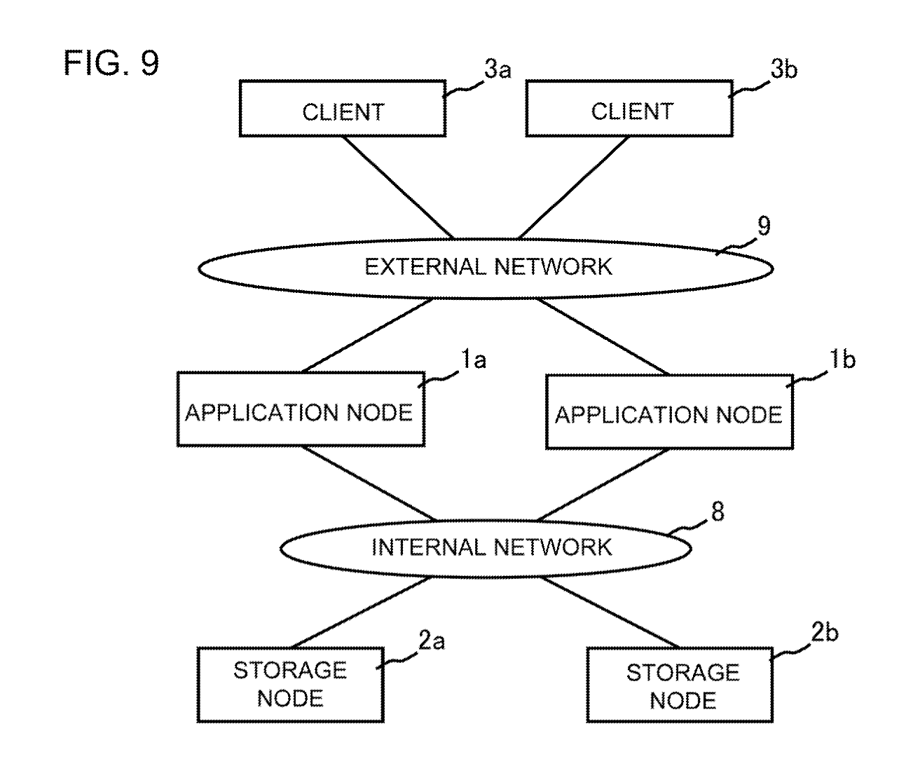

FIG. 9 is a system configuration diagram that further illustrates FIG. 1. An example of FIG. 9 has two application nodes 1a and 1b as application nodes 1, two storage nodes 2a and 2b as storage nodes 2, and two clients 3a and 3b as clients 3.

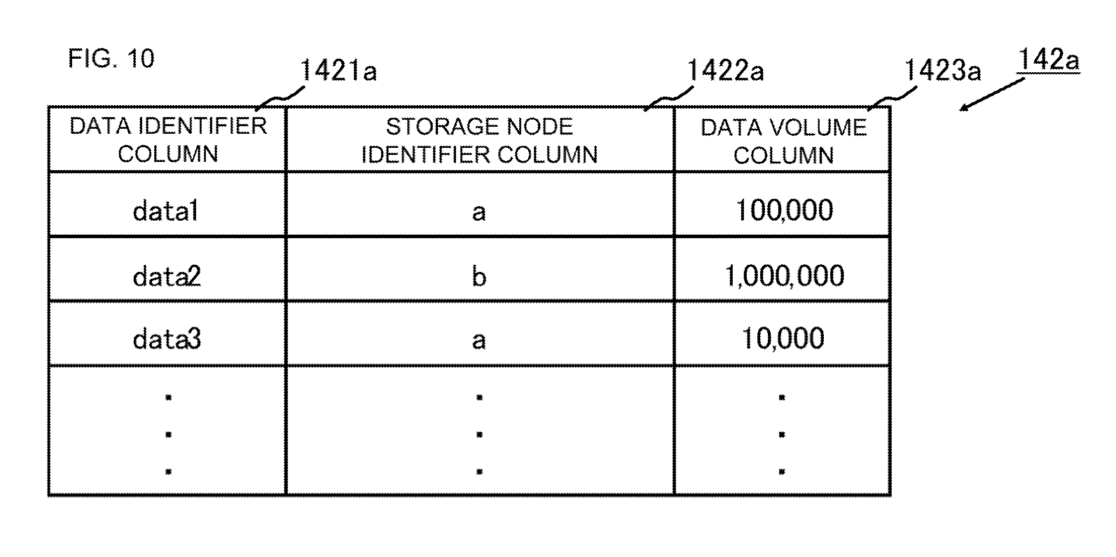

FIG. 10 is an example of data information of a data information storage unit 142a that is the data information storage unit 142 of the application node 1a. A value in a storage node identifier column 1422a corresponds to an index that identifies the storage node 2. For example, a value of the storage node identifier column 1422a of data of a data identifier “data 1”, is “a”. In this case, the data concerned is stored in the storage node 2a.

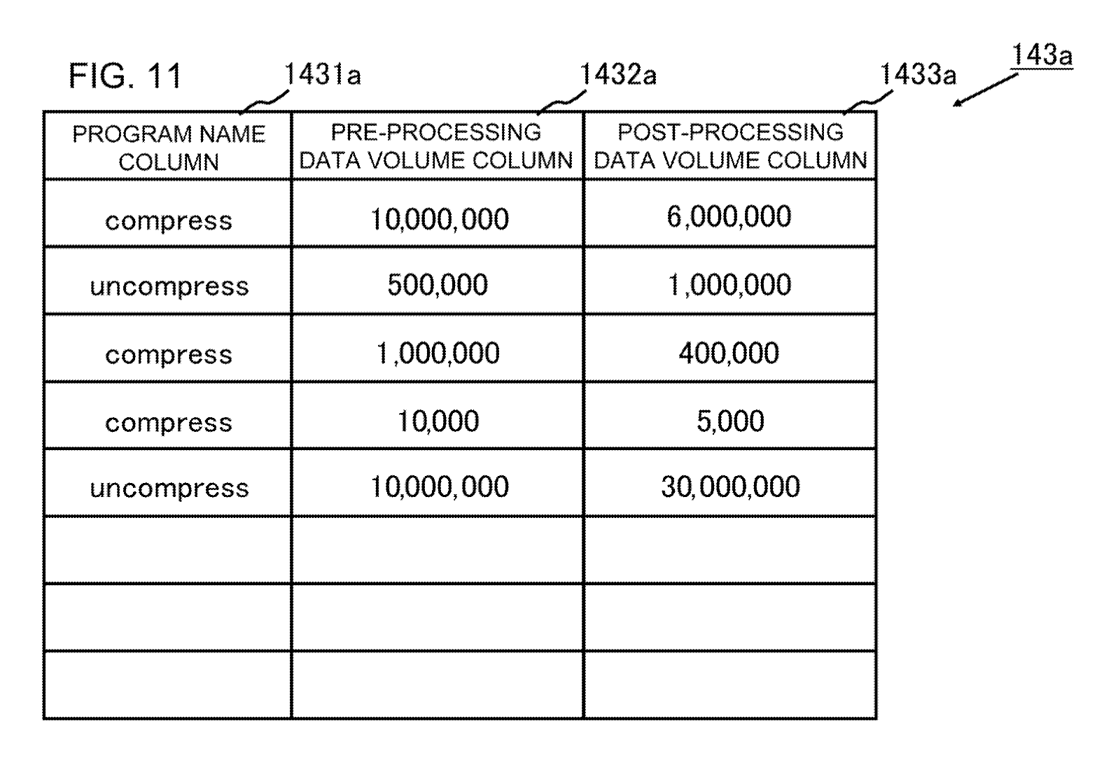

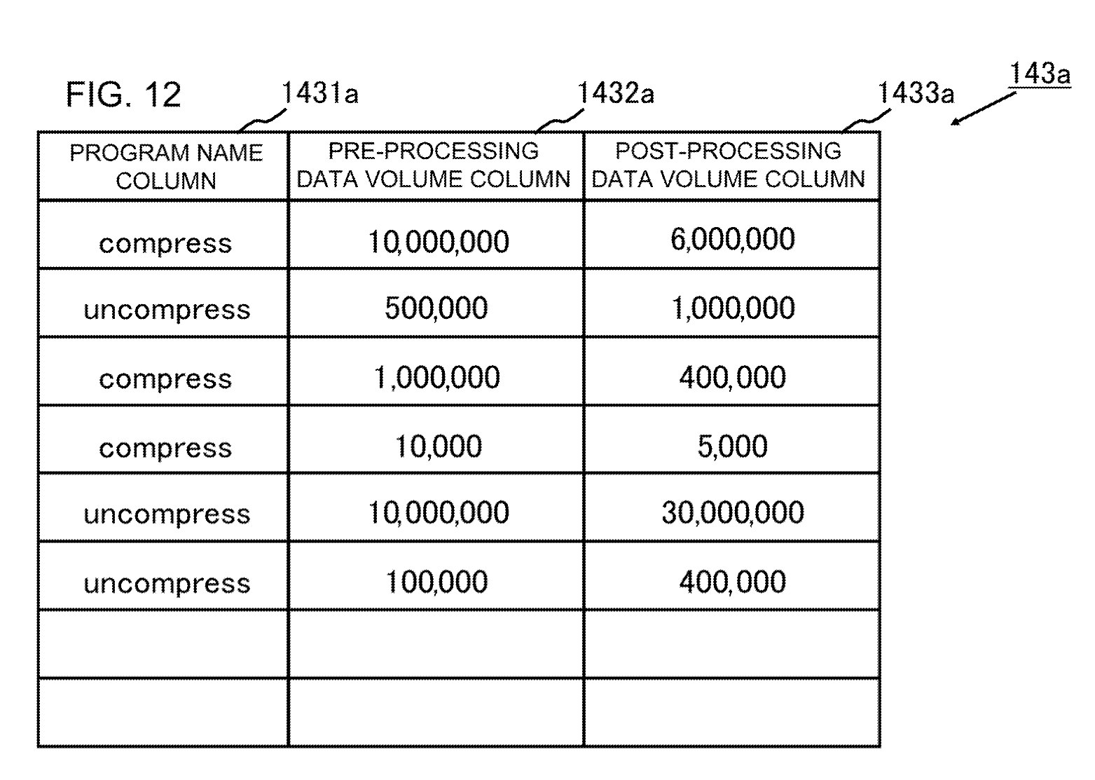

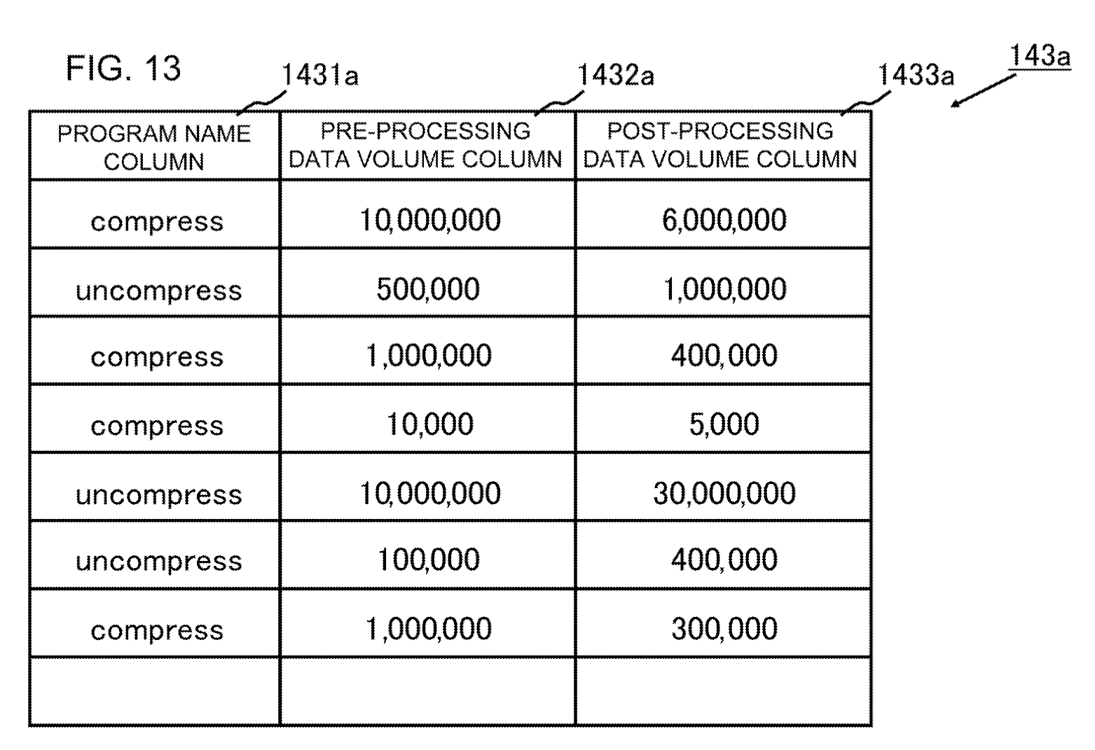

FIGS. 11 to 13 are diagrams representing transitions of states of a data volume storage unit 143a that is the data volume storage unit 143 of the application node 1a. “Compress” in FIGS. 11 to 13 indicates a program that compresses data stored in the program storage unit 141 or 241, and “uncompress” indicates a program that decompresses compressed data. In a case where the client 3 makes a processing request, indicating the program name “compress”, the application node 1 returns compressed data as a processing result to the client 3. Furthermore, in a case where the client 3 makes a processing request, indicating the program name “uncompress”, the application node 1 returns uncompressed data as a processing result to the client 3. It is to be noted that at the start time, the data volume storage unit 143a is in a state as in FIG. 11. FIG. 12 shows a state where, from the state of FIG. 11 the “uncompress” program is executed once, and the data volumes before and after “uncompress” processing is added. FIG. 13 shows a state where, from the state of FIG. 12 the “compress” program is executed once, and the data volume before and after “compress” processing is added.

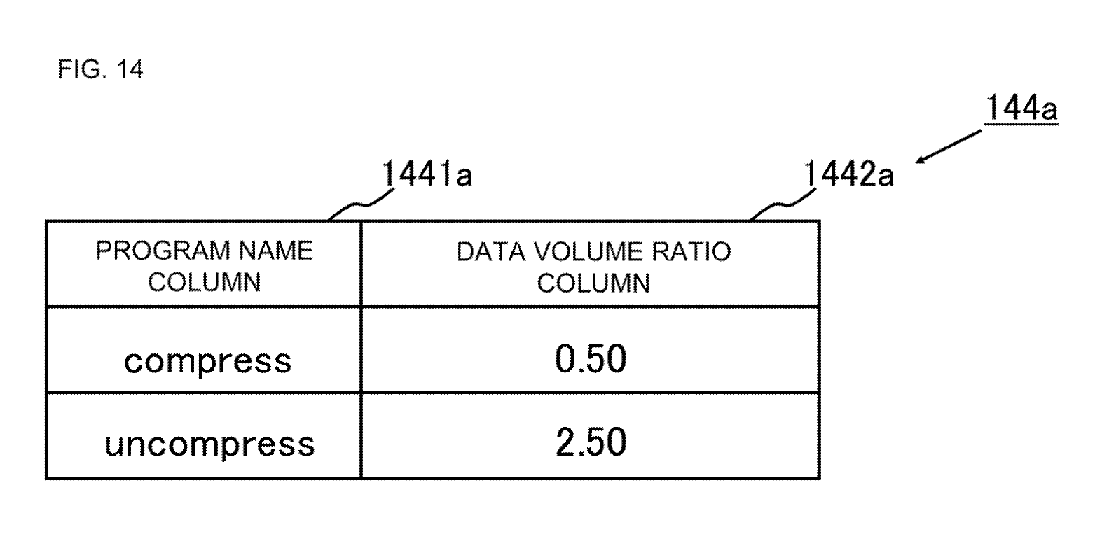

FIG. 14 to FIG. 16 are diagrams representing transitions of states of a data volume ratio storage unit 144a that is the data volume ratio storage unit 144 of the application node 1a in the present exemplary embodiment. It is to be noted that at the start time, the data volume ratio storage unit 144a is in a state as in FIG. 14. Values computed for respective data volume ratios for the “compress” program and the “uncompress” program of FIG. 11 are stored in a data volume ratio column 1442a of FIG. 14. That is, an average value of (6,000,000/10,000,000)=0.60, (400,000/1,000,000)=0.40, and (5,000/10,000)=0.50, of FIG. 11, that is 0.50, is stored in the “compress” row of FIG. 14. Furthermore, an average value of (1,000,000/500,000)=2.00 and (30,000,000/10,000,000)=3.00, of FIG. 11, that is 2.50, is stored in the “uncompress” row of FIG. 14.

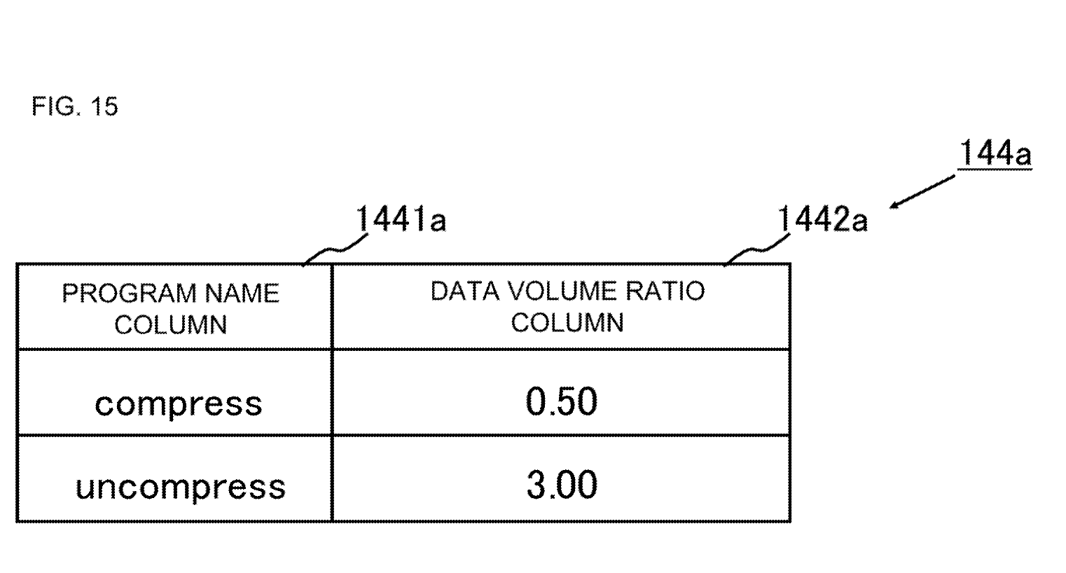

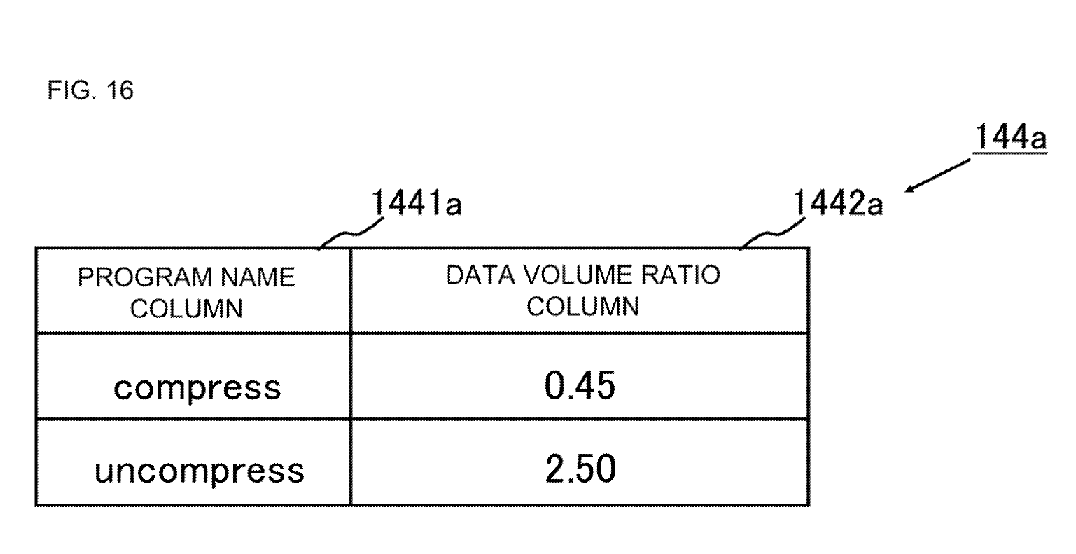

FIG. 15 shows a state of the data volume ratio storage unit 144a where, from the state of FIG. 14, the “uncompress” program is executed once, and a re-computation is performed from the data volumes before and after processing of FIG. 12. FIG. 16 shows a state of the data volume ratio storage unit 144a where, from the state of FIG. 15, a re-computation is performed from the data volumes before and after processing of FIG. 13.

Below, the data information storage unit 142a, the data volume storage unit 143a, and the data volume ratio storage unit 144a are respectively in the states of FIG. 10, FIG. 11, and FIG. 14, and a description is given concerning operations in a case of receiving respective processing requests from the clients 3a and 3b, making reference to FIG. 7 and FIG. 8.

In a case where the client 3a specifies the data identifier “datal” and the program name “uncompress”, with respect to the application node 1a and makes a processing request, the application node 1a refers to the value of the data volume ratio column 1442a at a row where the program name column 1441a of the data volume ratio storage unit 144a is “uncompress”. In this case, since the data volume ratio is 2.50 and is larger than 1 (step A3 in FIG. 7), the application node 1a refers to the storage node identifier column 1442a at a row where the value of the data identifier column 1421a of the data information storage unit 142a is “datal”. In this case, since the storage node identifier is “a”, the application node 1a makes a data request with respect to the storage node 2a (step A4 in FIG. 7). When the data “data 1” is received (step A5 in FIG. 7), the application node 1 a performs “uncompress” processing with “data 1” as input (step A6 in FIG. 7).

The data volume of “datal” received from the storage node 2a is 100,000 bytes, and the data volume after processing is assumed to be 400,000 bytes. The application node 1a adds a row to the data volume storage unit 143a, and stores “uncompress” in the program name column 1431a, 100,000 in the pre-processing data volume column 1432a, and 400,000 in the post-processing data volume column 1433a (step A7 in FIG. 7).

FIG. 12 shows a state of the data volume storage unit 143a at this point in time. Next, the application node 1 a transmits a processing result to the client 3a (step A8 in FIG. 7), computes the average value of the data volume ratio of rows where “uncompress” is the value of the program name column 1431a of the data volume storage unit 143a in the state of FIG. 12 (step A9 in FIG. 7), and updates the value of the data volume ratio column 1442a of a row where the program name column 1441a of the data volume ratio storage unit 144a is “uncompress” (step A10 in FIG. 7). FIG. 15 shows a state of the data volume ratio storage unit 144a at this point in time.

Next, a description is given concerning a case where the client 3b specifies a data identifier “data2” and a program name “compress” to the application node 1a, and makes a processing request.

The application node 1a refers to the value of the data volume ratio column 1442a at a row where the program name column 1441a of the data volume ratio storage unit 144a is “compress”. In this case, since the data volume ratio is 0.50 and is less than or equal to 1 (step A3 in FIG. 7), the application node 1a refers to the storage node identifier column 1442a at a row where the value of the data identifier column 1421a of the data information storage unit 142a is “data2”. In this case, since the storage node identifier is “b”, the application node 1 a makes a processing request with respect to the storage node 2b (step A11 in FIG. 7).

Next, on receiving the processing result from the storage node 2b (step A12 in FIG. 7) the application node 1 a checks the data volume of the data of the processing result. Here, the data volume of the processing result is assumed to be 300,000 bytes. Since it is known that the data volume of “data2”, which is the data before processing, is 1,000,000 bytes by making reference to the data volume column 1423a at a row where the data identifier column 1421a of the data information storage unit 142a is “data2”, the application node 1a adds a row to the data volume storage unit 143a, and stores “compress” in the program name column 1431a, 1,000,000 in the pre-processing data volume column 1432a, and 300,000 in the post-processing data volume column 1 433a (step A13 in FIG. 7).

FIG. 13 shows a state of the data volume storage unit 143a at this point in time. Next, the application node 1a transmits a processing result to the client 3a (step A8 in FIG. 7), computes the average value of the data volume ratio of rows where “compress” is the value of the program name column 1431a of the data volume storage unit 143a in the state of FIG. 13 (step A9 in FIG. 7), and updates the value of the data volume ratio column 1442a of a row where the program name column 1441a of the data volume ratio storage unit 144a is “compress” (step A10 in FIG. 7). FIG. 16 shows a state of the data volume ratio storage unit 144a at this point in time.

In processing with regard to the processing requests from these two clients 3a and 3b, communication traffic volume from the storage node 2 to the application node 1 is 400,000 bytes, which is a total of 100,000 bytes (see FIG. 12 (column 1432a of last line)) that is the data volume of the data before the “uncompress” processing, and 300,000 bytes (see FIG. 13 (column 1433a of last line)) that is the data volume of the “compress” processing result.

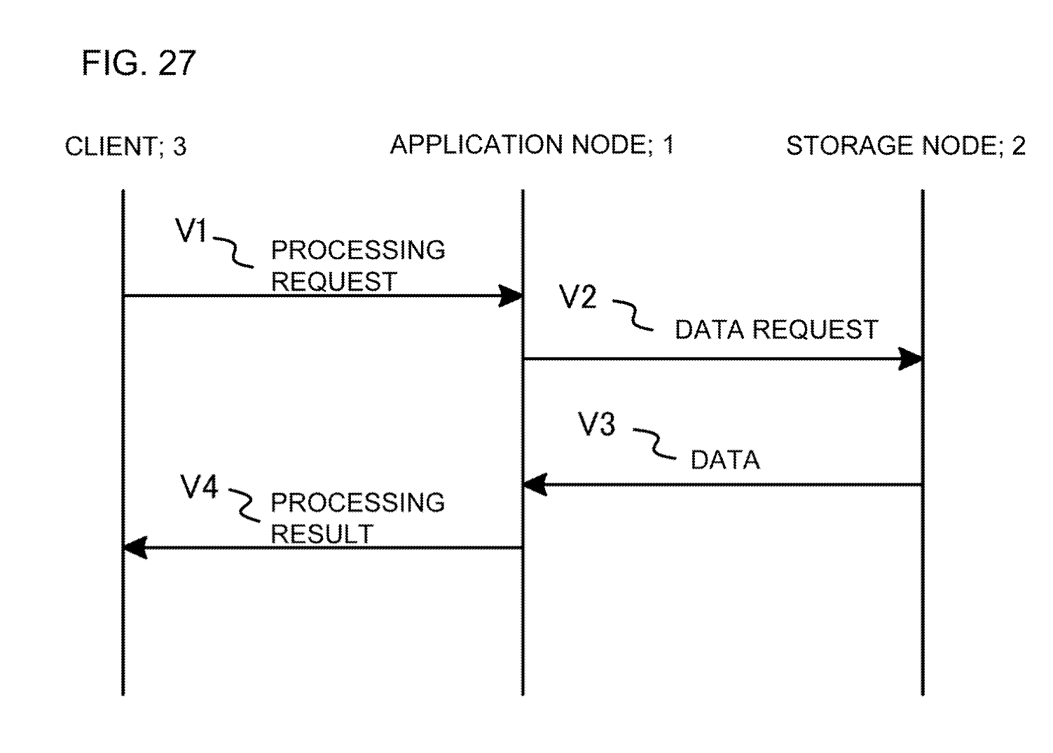

However, as described using FIG. 27 at the start of this document, with regard to all processing requests, in a case where the application node 1 makes a data request to the storage node 2, the data volume exchanged between the storage node 2 and the application node 1 is 1,100,000, which is a total of 100,000 bytes that is the data volume of the data before the “uncompress” processing, and 1,000,000 bytes that is the data volume of the data before the “compress” processing.

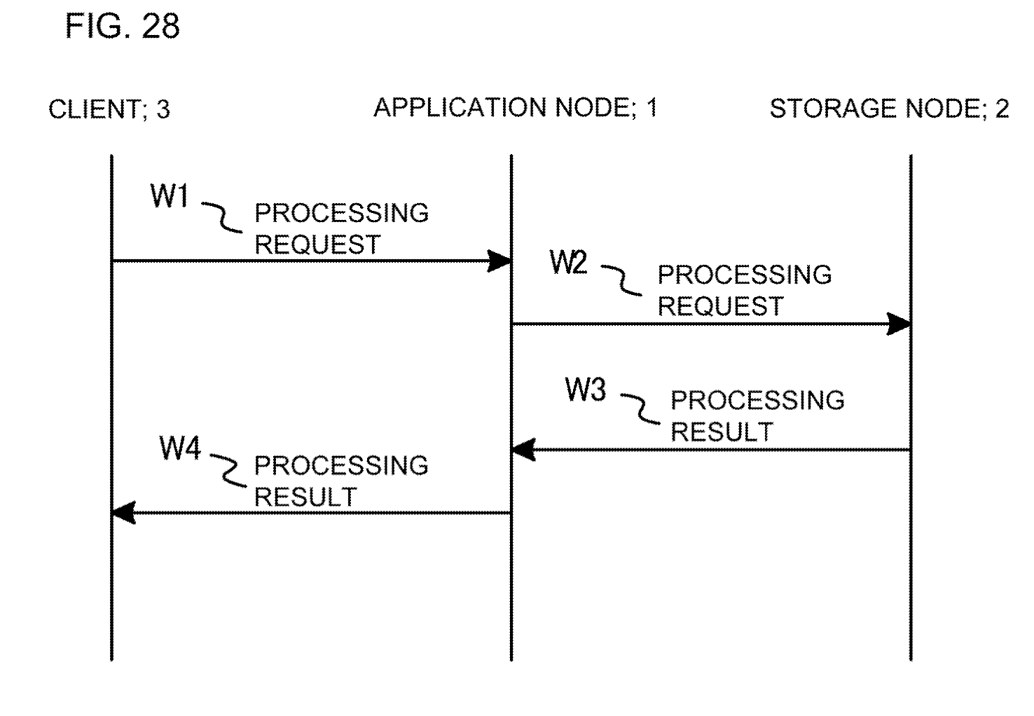

Furthermore, as described using FIG. 28 at the start of this document, with regard to all processing requests, in a case where the application node 1 makes a processing request to the storage node 2, the data volume exchanged between the storage node 2 and the application node 1 is 700,000, which is a total of 400,000 bytes that is the data volume of the “uncompress” processing result, and 300,000 bytes that is the data volume of the “compress” processing result.

As described above, according to the present invention, it is possible to greatly reduce the data volume exchanged between the storage node 2 and the application node 1.

A reason for this is that a configuration is employed in which the history of the data volumes before and after processing is recorded for each program, the ratio of the data volumes before and after processing is computed, and a decision is made as to whether processing is performed by the application node or is performed by the storage node according to the ratio of the data volumes. Clearly, instead of the ratio of the data volumes as described above, in a case of executing processing by the application node 1 and the storage node 2, it is also possible to employ other methods as long as respective data volumes exchanged between the two nodes are computed, and processing is executed at the node where it is possible to reduce the sum of the data volumes flowing between the two nodes.

As a further example, in the first exemplary embodiment described above a judgment was made as to whether or not the data volume ratio is larger than 1 or less than or equal to 1, but it is possible to make a judgment based on another value. For example, in accordance with whether processing is executed by either the application node 1 or the storage node 2, in a case where communication data volumes required for the application node 1 to transmit a request to the storage node 2 are different, it is possible to use a value in which a correction of that quantity is added.

Furthermore, in the first exemplary embodiment described above, a description was given in which the application node and the storage node have the same program group beforehand, but a mode is also possible in which, for example, the application node 1 transmits a program to the storage node 2, as necessary. In this case, in order to determine a processing node, rather than use the ratio of data volumes before and after processing as it is, it is possible to make a correction taking into account the data volume generated by transmitting the program.

Furthermore, in the first exemplary embodiment described above, a description was given concerning a mode in which each application node 1 individually performed storage of the data volumes before and after processing and performed computation of the data volume ratio, but, for example, information of the data volumes before and after processing and the data volume ratio can be shared between a plurality of application nodes.

Furthermore, in the first exemplary embodiment described above, a description was given in which storage of the data volumes before and after processing and computation of the data volume ratio are performed each time processing is executed, but, for example, it is possible to perform storage of the data volumes before and after processing for several executions of the processing, and to perform computation of the data volume ratio after data volumes before and after processing greater than or equal to a fixed amount have been added and stored.

### Second Exemplary Embodiment

Next, a detailed description is given concerning a second exemplary embodiment of the present invention, making reference to the drawings.

An overall configuration of the present exemplary embodiment is as shown in FIG. 1, similar to the first exemplary embodiment of the present invention described above, with detailed configurations of application nodes 1 and storage nodes 2 being different. A description is given below concerning portions that are different from the first exemplary embodiment of the present invention.

### (Configuration of Application Node 1)

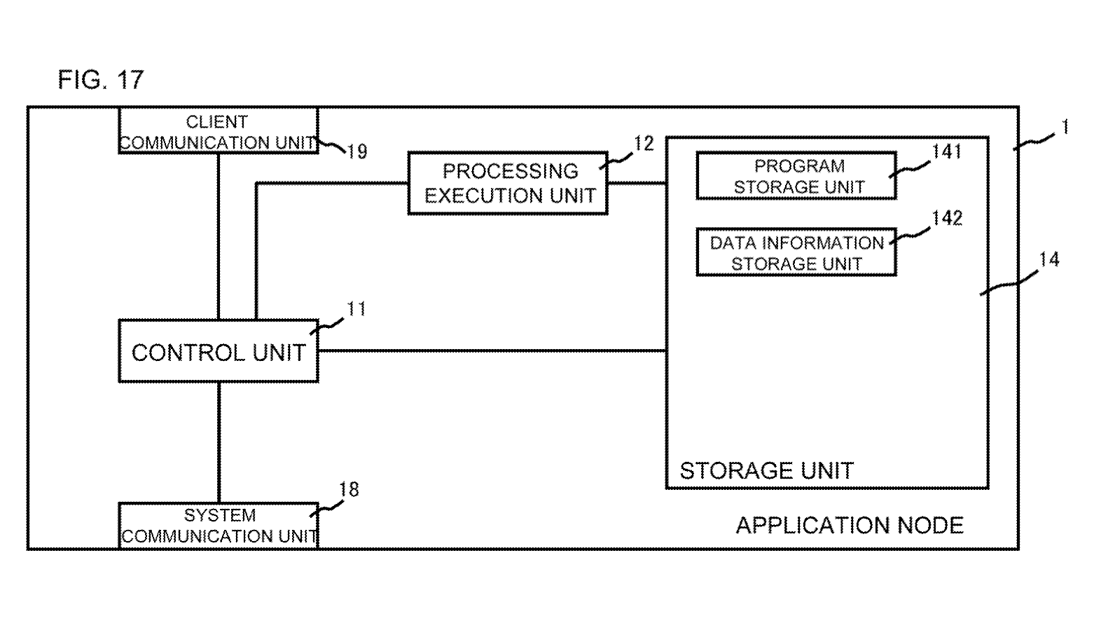

FIG. 17 is a diagram showing a configuration of the application node 1 in the present exemplary embodiment. A difference from FIG. 2 that shows a configuration of an application node 1 of the first exemplary embodiment of the present invention is the point that the application node 1 does not have a data volume ratio computation unit 13, a data volume storage unit 143, and a data volume ratio storage unit 144. Furthermore, a data information storage unit 142 of the application node 1 of the present exemplary embodiment has a different data structure from the data information storage unit 142 of the first exemplary embodiment shown in FIG. 4.

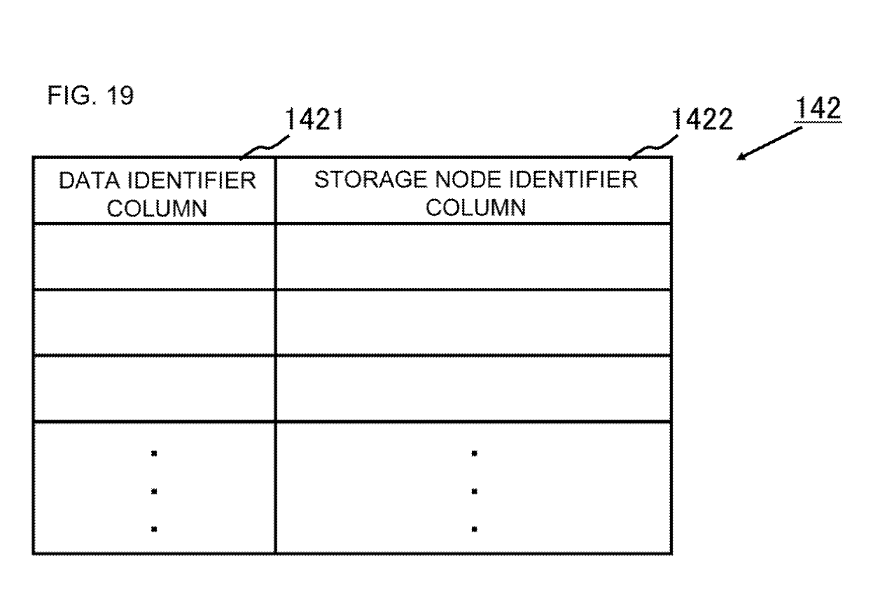

FIG. 19 is a diagram showing a structure of the data information storage unit 142 of the second exemplary embodiment of the present invention. There is a difference from the data information storage unit 142 of the first exemplary embodiment in the point that the second exemplary embodiment does not have a data volume column 1423.

### (Configuration of Storage Node 2)

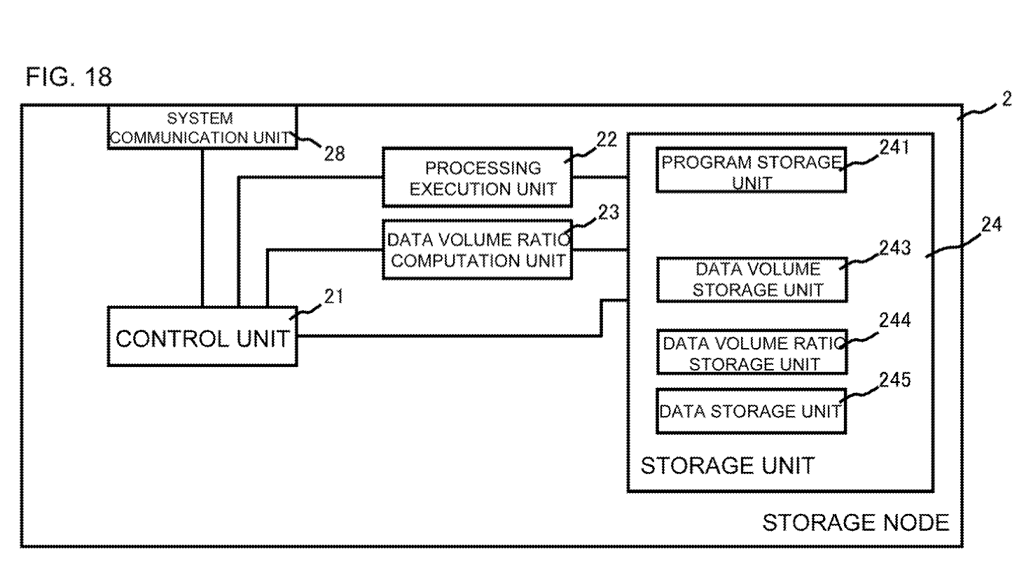

FIG. 18 is a diagram showing a configuration of a storage node 2 in the present exemplary embodiment. A point of difference from FIG. 3 that shows a configuration of the storage node 2 of the first exemplary embodiment of the present invention is that the storage node 2 has a data volume ratio computation unit 23, a data volume storage unit 243, and a data volume ratio storage unit 244.

The data volume ratio computation unit 23 corresponds to the data volume ratio computation unit 13 of the application node 1 of the first exemplary embodiment, and performs a similar operation.

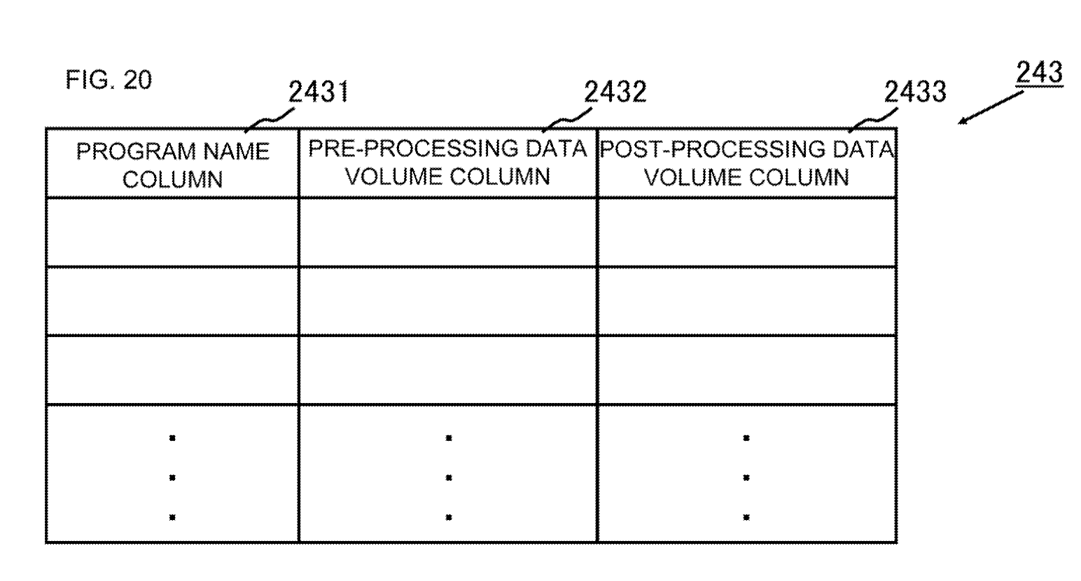

FIG. 20 is a diagram showing a structure of the data volume storage unit 243 of the second exemplary embodiment of the present invention. This has a similar structure to the data volume storage unit 143 of the first exemplary embodiment shown in FIG. 5.

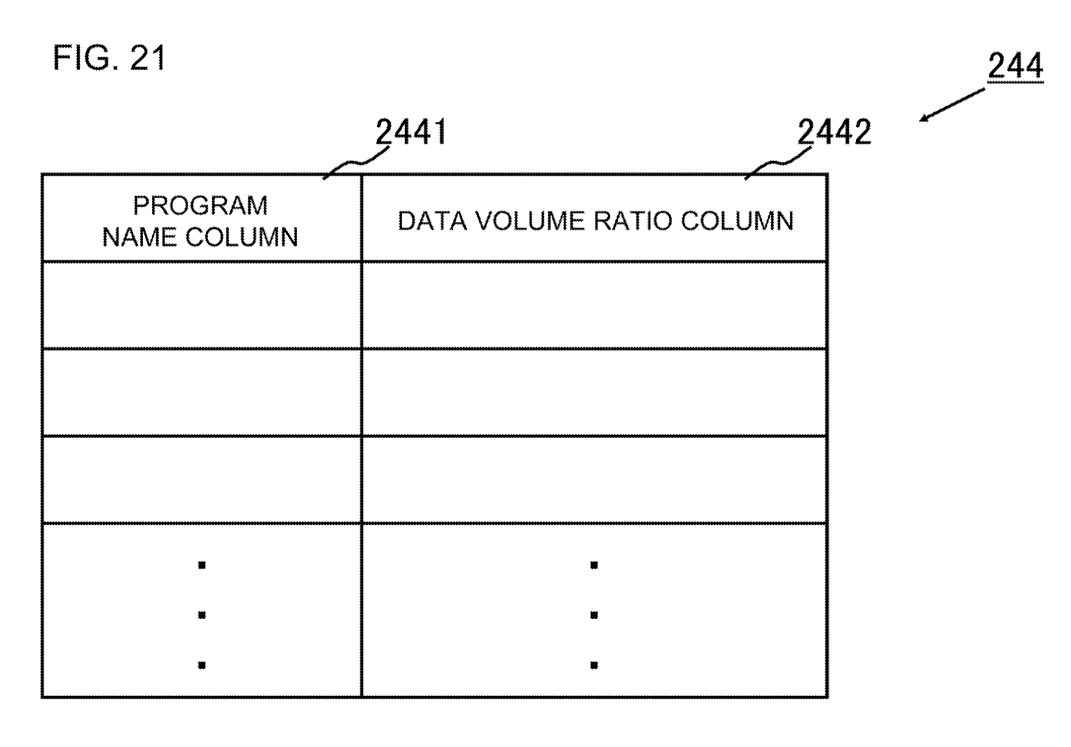

FIG. 21 is a diagram showing a structure of the data volume ratio storage unit 244 of the second exemplary embodiment of the present invention. This has a similar structure to the data volume ratio storage unit 144 of the first exemplary embodiment shown in FIG. 6.

### (Operation of Application Node 1)

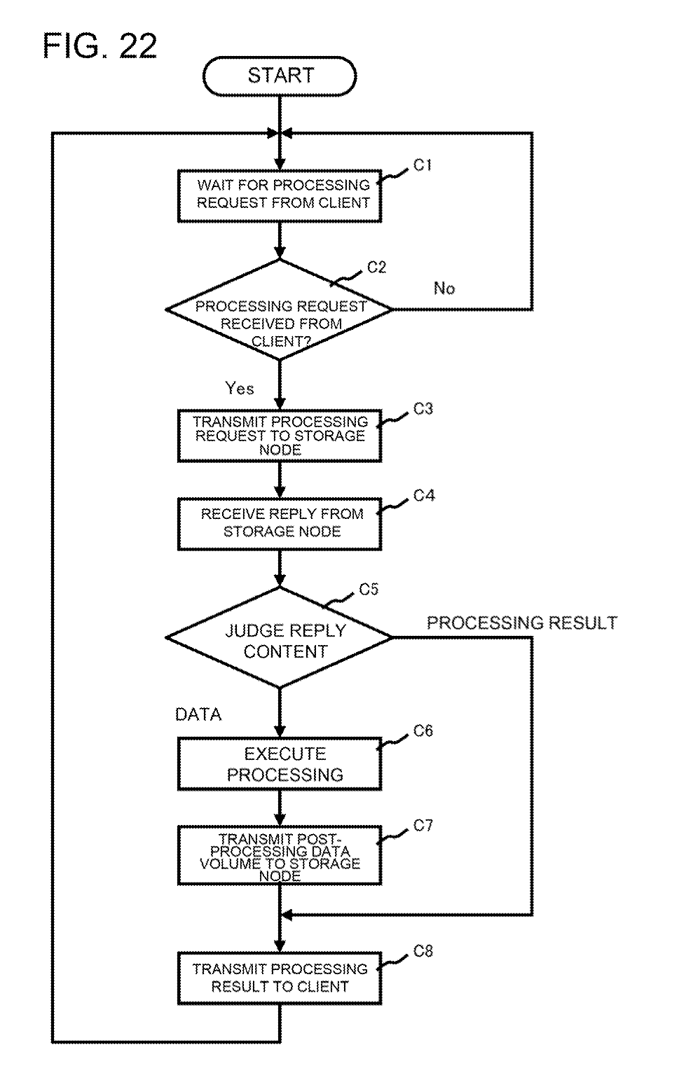

Next, a description is given concerning operation of the application node 1 of the present exemplary embodiment, making reference to a flowchart of FIG. 22.

First, the application node 1 waits to receive a processing request from a client 3 (step C1 in FIG. 22), and on receiving a processing request from the client 3 (step C2), transmits the processing request to the storage node 2 (step C3).

In step C3, the storage node 2 to which the processing request is transmitted is assumed to be a storage node 2 that corresponds to a storage node identifier stored in the storage node identifier column 1422 in a row where a value of a data identifier column 1421 of the data information storage unit 142 matches the data identifier included in the processing request. It is to be noted that the transmitted processing request includes a program name and data identifier specified in the processing request received from the client 3.

Next, on receiving a reply from the storage node 2 (step C4), the application node 1 judges whether the reply content is data or is a processing result (step C5). In step C5, in a case where the reply content is data, the application node 1 executes an appropriate program in a processing execution unit 12 with received data as input (step C6), and the data volume of the processing result is transmitted to the storage node 2 that has replied with the data (step C7). Next, the application node 1 transmits a processing result to the client 3 that is the source of the processing request (step C8). Thereafter, the application node 1 returns to step C1 and transitions to a state of waiting for a processing request from a client.

On the other hand, in step C5, in a case where the reply content is a processing result, the application node t transmits the processing result to the client 3 that is the source of the processing request (step C8). Thereafter, the application node 1 returns to step C1 and transitions to a state of waiting for a processing request from a client.

### (Operation of Storage Node 2)

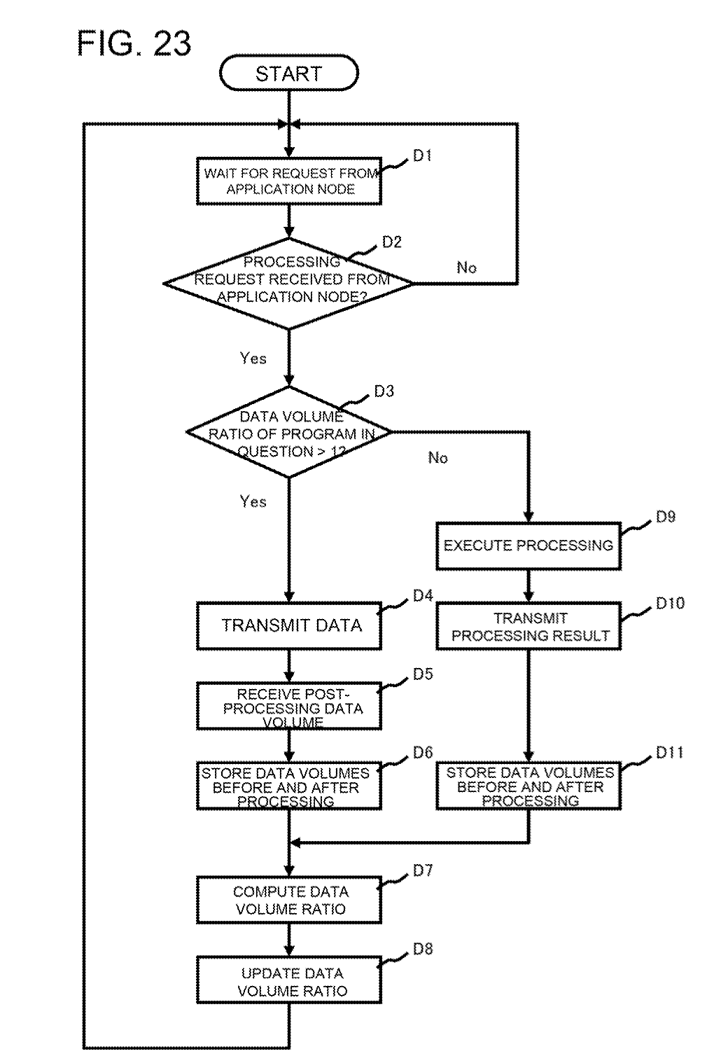

Next, a description is given concerning operation of the storage node 2 of the present exemplary embodiment, making reference to a flowchart of FIG. 23.

First, the storage node 2 waits for a processing request from the application node 1 (step D1 in FIG. 23), and on receiving the processing request from the application node 1 (step D2), searches for a row matching a program name included in the processing request, from a program name column 2441 of the data volume ratio storage unit 244, and checks whether the value of a data volume ratio, stored in a data volume ratio column 2442 in the row in question, is larger than 1 or is less than or equal to 1 (step D3).

In step D3, in a case where the data volume ratio is larger than 1, the storage node 2 reads data corresponding to a data identifier included in the data request from a data storage unit 245, transmits the data and information indicating that it is data, to an application server 1 that is the source of the processing request (step D4), and waits for reception of post-processing data volume from the application server 1.

On receiving the post-processing data volume from the application server 1 (step D5), the storage node 2 secures a new row of the data volume storage unit 243, and respectively stores: a program name included in the processing request, in the program name column 2431, the data volume of the data transmitted to the application server 1 in step D4, in a pre-processing data volume column 2432, and a post-processing data volume received from the application server 1 in step D5, in a post-processing data volume column 2433 (step D6). Next, the data volume ratio computation unit 23 computes the value of the post-processing data volume divided by the pre-processing data volume for all rows where the program name column 2431 of the data volume storage unit 243 holds the program name in question, and takes an average value thereof as a data volume ratio (step D7). Next, the storage node 2 updates the data volume ratio column 2442 in the row where the program name in question is stored in the program name column 2441 of the data volume ratio storage unit 244, to the value of the computed data volume ratio (step D8). Thereafter, the storage node 2 returns to step D1 and transitions to a state of waiting for a processing request from the application node 1.

On the other hand, in a case where the data volume ratio in step D3 is less than or equal to 1, the storage node 2 executes an appropriate program in a processing execution unit 22 with data corresponding to the data identifier included in the processing request as input (step D9), and transmits a processing result and information indicating that this is a processing result to the application server 1 that is the source of the processing request (step D10).

Next, the storage node 2 secures a new row of the data volume storage unit 243, and respectively stores: a program name included in the processing request, in the program name column 2431; the data volume of the data as input for processing execution in step D9, in the pre-processing data volume column 2432; and the data volume of the data of the processing result of step D9, in the post-processing data volume column 1433 (step D11). Thereafter, the storage node 2 performs processing of step D7 and following, similar to the previous case where the data volume ratio is larger than 1.

It is to be noted that in step D6 or in step D11, in a case where a new row cannot be secured due to there being little storage capacity in the data volume storage unit 243, the number of rows in the table of the data volume storage unit 243 is counted for each program name, the oldest row of the program name with the most rows is deleted, and storage area for a new row is obtained. Furthermore, a configuration is possible in which a predetermined number of rows is secured and old data rows are deleted in sequence, for each program.

As described above, even with a configuration where processing is performed to select a processing node on a storage node side, similar to the first exemplary embodiment, it is possible to reduce the data volume exchanged between the application node 1 and the storage node 2. A reason for this, similar to the first exemplary embodiment described above, is that a configuration is used in which the history of the data volume before and after processing is recorded for each program, the ratio of the data volumes before and after processing is computed, and a decision is made as to whether processing is to be performed by an application node or is to be performed by a storage node according to the ratio of the data volumes.

It is to be noted that in the present exemplary embodiment, in a case of performing processing by the application node 1, a communication is added to transmit the data volume of a processing result from the application node to the storage node, and since the communication traffic volume can be implemented by approximately from several bytes to several hundred bytes, in a system in which the difference in the data volumes before and after processing exceeds several kilobytes, the effect is very insignificant, and it is possible to reduce the total data volume exchanged between the two nodes.

### Third Exemplary Embodiment

Next, a detailed description is given concerning a third exemplary embodiment of the present invention in which modifications are added to the first exemplary embodiment described above, with reference being made to the drawings.

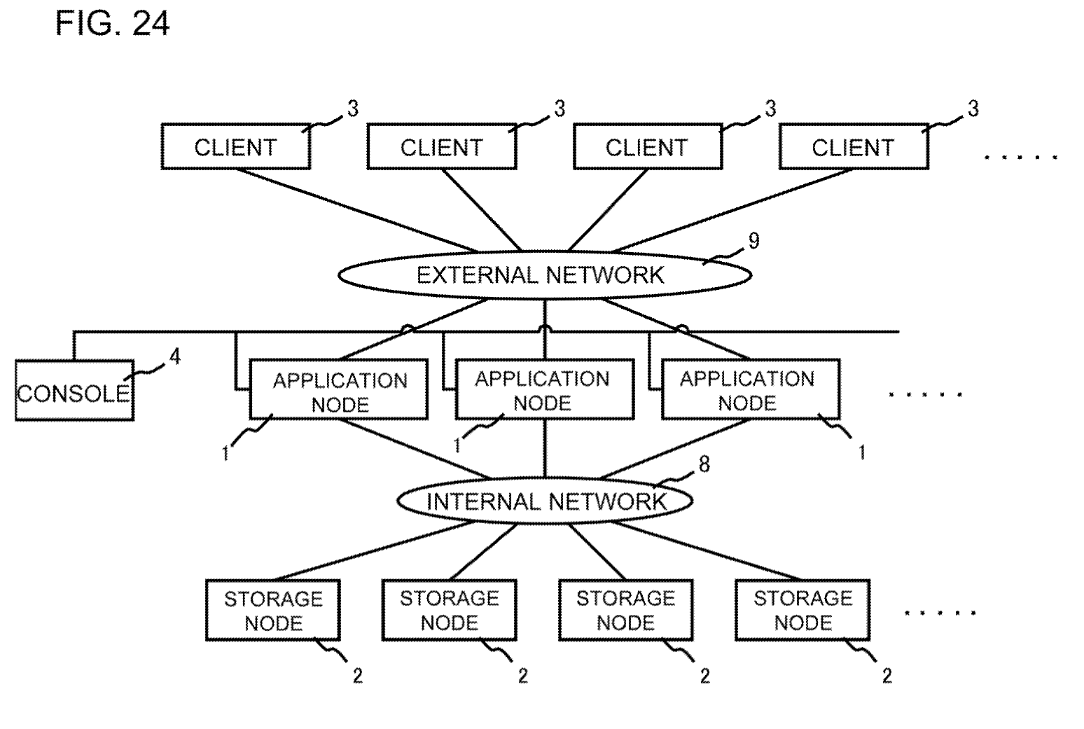

FIG. 24 is a diagram showing an overall configuration of a system of the present exemplary embodiment. Referring to FIG. 24, the present exemplary embodiment is different in the point that a console 4 is added to the configuration of the first exemplary embodiment in FIG. 1.

The console 4 is an interface device for displaying an internal state of an application node 1, or for an operator to perform a change of setting of the application node 1.

### (Configuration of Application Node 1)

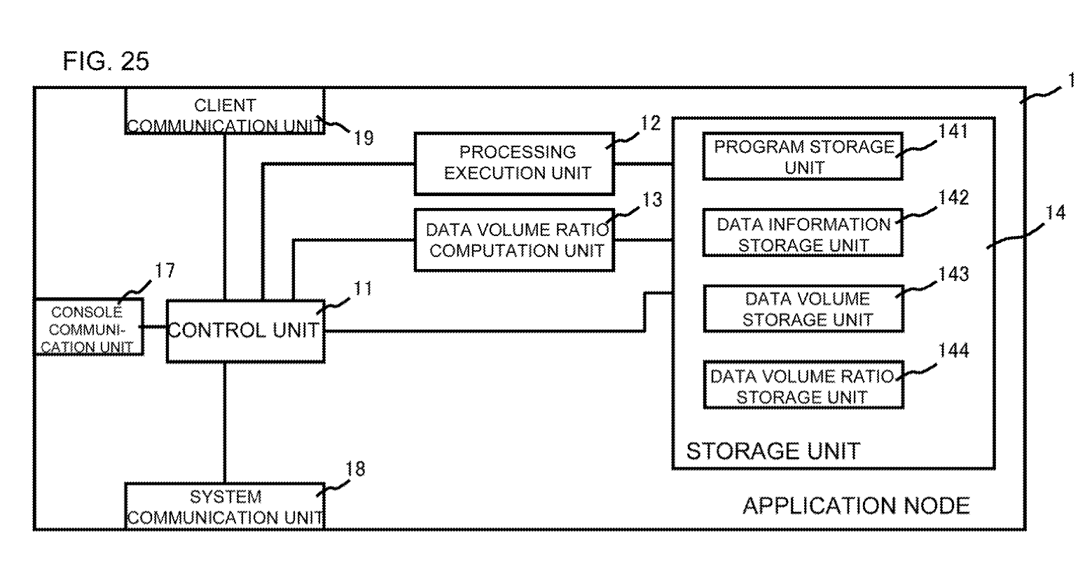

FIG. 25 is a diagram showing a configuration of the application node 1 in the present exemplary embodiment. There are differences from the application node 1 of the first exemplary embodiment shown in FIG. 2 in the point of having a console communication unit 17, and in the structure of a data volume ratio storage unit 144.

The console communication unit 17 functions as an interface between inside the application node 1 and the console 4.

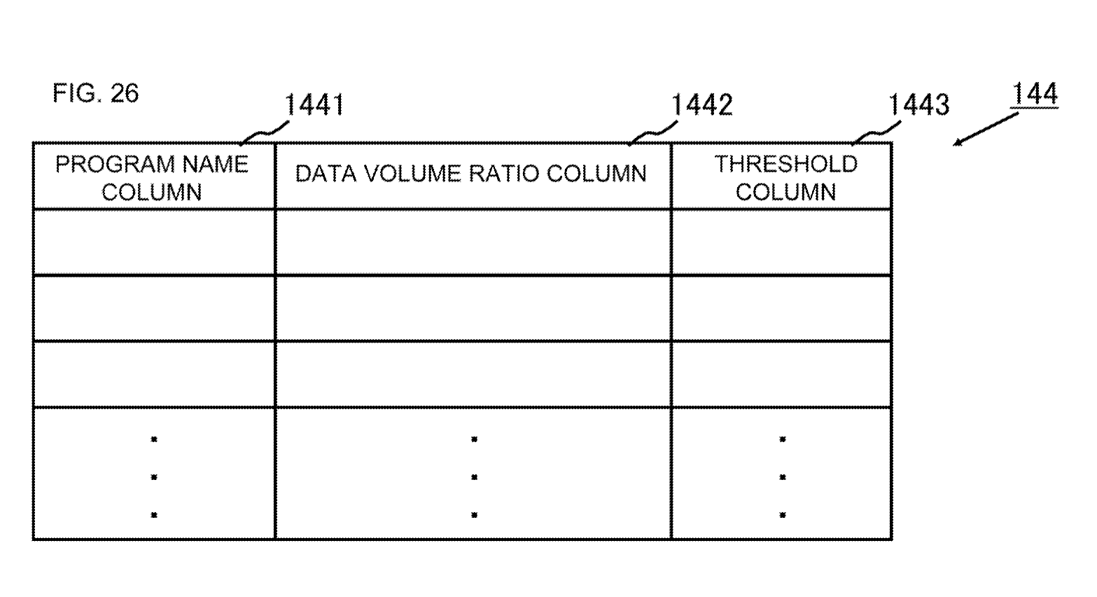

FIG. 26 is a diagram showing a structure of a data volume ratio storage unit 144 of the present exemplary embodiment. A point of difference from the data volume ratio storage unit 144 of the first exemplary embodiment shown in FIG. 6 is that the present exemplary embodiment has a threshold column 1443. Here, a threshold is a reference value in order to judge whether to perform processing execution by the application node 1 or by a storage node 2, by comparing data volume ratios.

The threshold is a numerical value greater than or equal to 0, and the larger the value, the easier it is to perform the processing execution by the storage node 2. Furthermore, the threshold need not be a numerical value, and it is possible to set a discriminating symbol to forcibly perform the processing execution by the application node 1, or to forcibly perform the processing execution by the storage node 2. A description will be given later concerning a method of selecting a specific node using the threshold.

### (Operation of Console 4)

The console 4 makes a threshold setting request to the application node 1, in accordance with an operation of an operator. The threshold setting request includes a program name and a threshold. The operator need not necessarily specify the threshold by a numerical value. For example, specifying is possible by a track bar or a pulldown menu of a GUI (Graphical User Interface), and handling as a threshold is possible by conversion to a numerical value inside the console 4.

### (Operation of Application Node 1)

On receiving a threshold setting request from the console 4, the application 1 stores a threshold included in the threshold setting request, in the threshold column 1443 in a row where the value of a program name column 1441 of a data volume ratio storage unit 144 matches a program name included in the threshold setting request.

Since other operations of the application node 1 are the same, with the exception of step A3 of FIG. 7 that represents operation of the first exemplary embodiment, a description is given below using FIG. 7.

In step A3 of FIG. 7, a judgment was made as to whether a data volume ratio is larger than 1 or less than or equal to 1, but in the present exemplary embodiment, in a case where a value is set in the threshold column 1443 for a program in question, the threshold that is set is taken as a determining threshold. That is, in a case where the data volume ratio is larger than the threshold, or in a case where a setting was made to forcibly perform processing execution by the application node 1, the processing execution is performed by the application node 1 by transmitting a data request to the storage node 2. Furthermore, in a case where the data volume ratio is smaller than the threshold, or in a case where a setting was made to forcibly perform the processing execution by the storage node 2, a processing request is transmitted to the storage node 2.

As described above, in the present exemplary embodiment, in addition to an effect of the first exemplary embodiment, it is possible to change a reference as to whether to perform processing by the application node 1 or to perform processing by the storage node 2, for each processing content. In this regard, for example, in a case of a configuration in which a processing execution unit of the application node 1 can perform high speed processing for a specific process P, in comparison to a processing execution unit of a storage node, it is possible to have an arrangement such that a program performing the process P is executed only by the application node.

It is to be noted that the function by which a reference for judging a processing execution node can be set for each program added in the third exemplary embodiment of the invention described above can also be added to the second exemplary embodiment.

Descriptions of exemplary embodiments of the present invention have been given above, but the present invention is not limited to the abovementioned exemplary embodiments, and it is possible to further add modifications, substitutions, and adjustments, within a scope that does not depart from a fundamental technical concept of the present invention.

A description was given concerning a mode in which, in the abovementioned first exemplary embodiment and third exemplary embodiment the application node stores data volumes before and after processing, computes data volume ratios, and determines a processing node, and in the second exemplary embodiment the storage node stores data volumes before and after processing, computes data volume ratios, and determines a processing node, but the present invention is not limited to only these modes.

For example, it is possible to arrange a dedicated node (a third node) that stores data volumes before and after processing, computes data volume ratios, and determines a processing node, and the application node and the storage node perform communication with the dedicated node to perform equivalent processing. In this case, communication occurs between the dedicated node and the application node and storage node, but since the communication traffic volume can be implemented by approximately from several bytes to several 100 bytes, there is no change in the point that it is possible to reduce the total communication traffic volume in a system where the difference in data volumes before and after processing exceeds several kilobytes.

Furthermore, in the first, second, and third exemplary embodiments, a description was given concerning a system according to three layers: of clients, application nodes, and storage nodes, but the present invention is not limited to this configuration. With regard to a system of a type such that with two nodes having a resource by which processing can be executed, one thereof has processing data, the present invention can be generally applied to a system that determines which of the nodes executes the processing. For example, in a case where, between a mobile terminal and a server, the server has data, the invention can be applied to a system that determines which of the mobile terminal and the server executes the processing.

The present invention can be applied to uses such as distributed computing. Furthermore, the invention can also be applied to distributed processing among a mobile terminal and a server. Finally, preferred modes of the present invention are summarized.

### Mode 1

(Refer to the processing node selection system according to the first aspect described above.)

### Mode 2

The processing node selection system may comprise:
a data volume storage unit that stores data volumes before and after processing;
a data volume ratio computation unit that uses the data volumes before and after processing to compute a ratio of data volumes before and after processing; and
a control unit that determines a node to execute the processing, based on the data volume ratio.

### Mode 3

In the processing node selection system, it is preferred that data volumes before and after processing are stored in the data volume storage unit, for each program used in processing;
the data volume ratio computation unit tallies data volumes before and after processing stored in the data volume storage unit, for each program, and computes a data volume ratio; and
the control unit determines a node to execute processing, based on the computed data volume ratio for each of the programs.

### Mode 4

In the processing node selection system, the first node may comprise the data volume storage unit, the data volume ratio computation unit, and the control unit; and
in the first node, a determination may be made, based on the data volume ratio, as to whether to request data from the second node and execute processing in the first node, or request execution of processing in the second node.

### Mode 5

In the processing node selection system, the second node may comprise the data volume storage unit, the data volume ratio computation unit, and the control unit; and
in the second node, a determination may be made, based on the data volume ratio, as to whether to transmit data to the first node and request execution of processing, execute processing in the second node, or request execution of processing in the second node.

### Mode 6

In the processing node selection system, a determination reference can be set based on the data volume ratio, for each processing content.

### Mode 7

(Refer to the information processing node according to the second aspect described above.)

### Mode 8

The information processing node may comprise:
a data volume storage unit that stores data volumes before and after processing;
a data volume ratio computation unit that uses the data volumes before and after processing to compute a ratio of data volumes before and after processing; and
a control unit that determines a node to execute processing, based on the data volume ratio.

### Mode 9

In the information processing node, data volumes before and after processing may be stored in the data volume storage unit, for each program used in processing;
the data volume ratio computation unit may tally data volumes before and after processing stored in the data volume storage unit, for each program, and computes a data volume ratio; and
the control unit may determine a node to execute processing, based on the data volume ratio computed for each of the programs.

### Mode 10

In the information processing node, a determination reference can be set based on the data volume ratio, for each processing content.

### Mode 11

An information processing node may be connected to a first node that has a processing resource, wherein,
when a processing request using data stored in the information processing node itself may be received from the first node, the information processing node selects an option in which total volume of data exchanged with the first node is smaller, among options of transmitting data used in the processing to the first node to execute the processing, or of executing the processing by the information processing node itself and transmitting a processing result thereof to the first node.

### Mode 12

The information processing node according to mode 11 may comprise:
a data volume storage unit that stores data volumes before and after processing;
a data volume ratio computation unit that uses the data volumes before and after processing to compute a ratio of data volumes before and after processing; and
a control unit that determines a node to execute processing, based on the data volume ratio.

### Mode 13

In the information processing node according to mode 12, it is preferred that data volumes before and after processing are stored in the data volume storage unit, for each program used in processing;
the data volume ratio computation unit tallies data volumes before and after processing stored in the data volume storage unit, for each program, and computes a data volume ratio; and
the control unit determines a node to execute processing, based on the data volume ratio computed for each of the programs.

### Mode 14

In the information processing node according to any one of modes 11 to 13, a determination reference can be set based on the data volume ratio, for each processing content.

### Mode 15

An information processing node may be connected to a first node that has a processing resource and a second node that has a processing resource and that stores data used in processing, wherein,
among options of causing the second node to execute processing so that the first node receives a processing result thereof, or of the first node receiving the data from the second node and executing the processing, a selection may be made of a node such that total volume of data exchanged between the first and second nodes is smaller, and a result of the selection may be notified to the first and second nodes.

### Mode 16

(Refer to the processing execution method according to the third aspect described above.)

### Mode 17

(Refer to the computer program according to the fourth aspect described above.)
It is to be noted that that each disclosure of the abovementioned patent document is incorporated herein by reference thereto.
Modifications and adjustments of embodiments and examples are possible within the bounds of the entire disclosure (including the scope of the claims) of the present invention, and also based on fundamental technological concepts thereof. Furthermore, a wide variety of combinations and selections of various disclosed elements is possible within the scope of the claims of the present invention.
That is, the present invention clearly includes every type of transformation and modification that a person skilled in the art can realize according to the entire disclosure including the scope of the claims and to technological concepts thereof.

### EXPLANATIONS OF SYMBOLS

1, 1a, 1b application node
11 control unit
12 processing execution unit
13 data volume ratio computation unit
14 storage unit
141 program storage unit
142, 142a data information storage unit
1421, 1421a data identifier column
1422, 1422a storage node identifier column
1423, 1423a data volume column
143, 143a data volume storage unit
1431, 1431a program name column
1432, 1432a pre-processing data volume column
1433, 1433a post-processing data volume column
144, 144a data volume ratio storage unit
1441, 1441a program name column
1442, 1442a data volume ratio column
1443 threshold column
17 console communication unit
18 system communication unit
19 client communication unit
2, 2a, 2b storage node
21 control unit
22 processing execution unit
23 data volume ratio computation unit
24 storage unit
241 program storage unit
243 data volume storage unit
2431 program name column
2432 pre-processing data volume column
2433 post-processing data volume column
244 data volume ratio storage unit
2441 program name column
2442 data volume ratio column
245 data storage unit
28 system communication unit
3, 3a, 3b client
4 console
8 internal network
9 external network
A1-A13, B1-B6, C1-C8, D1-D11 processing steps
V1-V4, W1-W4 communications

What is claimed is:

1. A processing node selection system comprising:
a first node that has a processing resource; and
a second node that has a processing resource and stores data used in processing; wherein
a selection is made of a node with a smaller total volume of data to be exchanged between said first and second nodes, as a node to execute said processing when processing is executed using data stored in said second node and said processing result is outputted by said first node.

2. The processing node selection system according to claim 1, comprising:
a data volume storage unit that stores data volumes before and after processing;
a data volume ratio computation unit that uses said data volumes before and after processing to compute a ratio of data volumes before and after processing; and
a control unit that determines a node to execute said processing, based on said data volume ratio.

3. The processing node selection system according to claim 2, wherein
data volumes before and after processing are stored in said data volume storage unit, for each program used in processing;
said data volume ratio computation unit tallies data volumes before and after processing stored in said data volume storage unit, for each program, and computes a data volume ratio; and
said control unit determines a node to execute processing, based on said computed data volume ratio for each of said programs.

4. The processing node selection system according to claim 2, wherein
said first node comprises said data volume storage unit, said data volume ratio computation unit, and said control unit; and
in said first node, a determination is made, based on said data volume ratio, as to whether to request data from said second node and execute processing in said first node, or request execution of processing in said second node.

5. The processing node selection system according to claim 2, wherein
said second node comprises said data volume storage unit, said data volume ratio computation unit, and said control unit; and
in said second node, a determination is made, based on said data volume ratio, as to whether to transmit data to said first node and request execution of processing, execute processing in said second node, or request execution of processing in said second node.

6. The processing node selection system according to claim 2, wherein a determination reference can be set based on said data volume ratio, for each processing content.

7. An information processing node connected to a second node that has a processing resource and stores data used in processing, wherein,
when processing is executed using data stored in said second node, said information processing node selects an option in which total volume of data exchanged with said second node is smaller, among options of causing said second node to execute said processing so as to receive a processing result thereof, or of receiving said data from said second node and executing said processing by said information processing node itself.

8. The information processing node according to claim 7 comprising:
a data volume storage unit that stores data volumes before and after processing;
a data volume ratio computation unit that uses said data volumes before and after processing to compute a ratio of data volumes before and after processing; and
a control unit that determines a node to execute processing, based on said data volume ratio.

9. The information processing node according to claim 8, wherein data volumes before and after processing are stored in said data volume storage unit, for each program used in processing;
said data volume ratio computation unit tallies data volumes before and after processing stored in said data volume storage unit, for each program, and computes a data volume ratio; and
said control unit determines a node to execute processing, based on said data volume ratio computed for each of said programs.

10. The information processing node according to claim 7, wherein a determination reference can be set based on said data volume ratio, for each processing content.

11-15. (canceled)

16. A processing execution method of executing processing by either of a first node that has a processing resource, and a second node that has a processing resource and stores data used in processing; said method comprising:
a step of selecting a node with a smaller total volume of data to be exchanged between said first and second nodes, among either of a case of transmitting data stored in said second node to said first node and executing processing by said first node, or a case of executing processing by said second node and transmitting a processing result thereof to said first node; and
a step in which said selected node executes said processing.

17. (canceled)

18. The processing node selection system according to claim 3, wherein
said first node comprises said data volume storage unit, said data volume ratio computation unit, and said control unit; and
in said first node, a determination is made, based on said data volume ratio, as to whether to request data from said second node and execute processing in said first node, or request execution of processing in said second node.

19. The processing node selection system according to claim 3, wherein
said second node comprises said data volume storage unit, said data volume ratio computation unit, and said control unit; and
in said second node, a determination is made, based on said data volume ratio, as to whether to transmit data to said first node and request execution of processing, execute processing in said second node, or request execution of processing in said second node.

20. The processing node selection system according to claim 3, wherein a determination reference can be set based on said data volume ratio, for each processing content.

21. The processing node selection system according to claim 4, wherein a determination reference can be set based on said data volume ratio, for each processing content.

22. The processing node selection system according to claim 5, wherein a determination reference can be set based on said data volume ratio, for each processing content.

23. The information processing node according to claim 8, wherein a determination reference can be set based on said data volume ratio, for each processing content.

24. The information processing node according to claim 9, wherein a determination reference can be set based on said data volume ratio, for each processing content.
